(19) United States
(12) Patent Application Publication
(10) Pub. No.: US 2025/0148020 A1
(43) Pub. Date: May 8, 2025

(54) AUTOMATED DOCUMENT ANALYSIS

(71) Applicant: LegalZoom.com, Inc., Glendale, CA (US)

(72) Inventors: Vivek Kumar Padmashali, Bangalore (IN); Gaurav Garsa, Rajasthan (IN); Selvaraj Karuppusamyu, Tamilnadu (IN); Rachit Kumar, Uttar Pradesh (IN); Jonah Back, Glendale, CA (US); James Donald Peters, Austin, TX (US)

(21) Appl. No.: 18/939,956

(22) Filed: Nov. 7, 2024

(30) Foreign Application Priority Data
Nov. 8, 2023 (IN) 202311076214

(51) Int. Cl. G06F 16/93; G06F 40/103

(52) U.S. Cl. CPC G06F 16/93; G06F 40/103

(57) ABSTRACT

Example systems and methods for analyzing and summarizing legal documents using artificial intelligence are disclosed. A system receives a legal document such as a contract or agreement, and utilizes multiple AI models in combination to process and summarize the document. This includes identifying the type of legal document using a natural language model, and then extracting key information like parties, dates, and monetary values. Related clauses within the document are consolidated using a clause consolidation algorithm even if they are not contiguous. Summaries are generated for each section of the document. Additionally, a question-answering module preemptively generates common questions and answers about the agreement to highlight key considerations for the parties involved. By leveraging an ensemble of customized AI models, the system aims to simplify comprehension of legal documents.

### PRIORITY CLAIM

This application claims the benefit of priority to Indian Provisional Patent Application No. 202311076214, filed on Nov. 8, 2023, which is hereby incorporated by reference in its entirety.

### BACKGROUND

Legal documents such as contracts and agreements are ubiquitous in business and legal settings. However, these documents can often be lengthy, complex, and difficult to parse. Significant time and effort are required to review and analyze the critical information contained in legal agreements.

Traditionally, the review and analysis of contracts and other legal documents has been a manual process. This can be an arduous task, as legal language is often complex and nuanced. Identifying key terms, obligations, dates, and other vital information often requires very careful reading. For long, detailed agreements, this manual document analysis process is extremely labor-intensive.

The field of artificial intelligence has seen significant advances in recent years. Natural language processing techniques allow machines to analyze and interpret human language with increasing sophistication. Machine learning algorithms can be trained to mimic human-level comprehension and reasoning abilities in specialized domains.

Modern legal practice must balance thorough, careful document review with the need for efficiency in high-volume legal transactions. As legal agreements and contracts continue to proliferate, solutions that can augment and enhance the human analysis process are becoming increasingly important.

Further, while natural language processing has made strides in analyzing documents, significant challenges remain in handling complex legal agreements. Legal documents contain nuanced language and domain-specific knowledge that can be difficult for AI systems to fully comprehend.

Tailoring analysis specifically based on the type of legal agreement is also technically challenging. Contracts for different purposes contain specialized language, and background knowledge is required to focus on the most salient information.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. It should be understood that additional and alternative examples are possible without departing from the principles of the present disclosure.

FIG. 1 is a block diagram showing a workflow of a document assistant system, according to some examples.

FIG. 2 is a block diagram illustrating an architecture of a document assistant system, according to some examples.

FIG. 3 is a flowchart of a summarization operation, according to some examples.

FIG. 4 is a flowchart of a highlight generation operation, according to some examples.

FIG. 5 is a flowchart of a FAQ operation, according to some examples.

FIGS. 6A-6B are flowcharts of clauses operations, according to some examples.

FIG. 7 illustrates a user interface showing a landing page, according to some examples.

FIG. 8 illustrates a user interface showing an asset page, according to some examples.

FIG. 9 illustrates a user interface showing a summary page, according to some examples.

FIG. 10 illustrates a user interface showing a clauses page, according to some examples.

FIG. 11 illustrates a user interface showing an FAQ page, according to some examples.

FIG. 12 illustrates a user interface showing a navigation page, according to some examples.

FIG. 13 illustrates a user interface showing a navigation page, according to some examples.

FIG. 14 illustrates a user interface showing an upload modal page, according to some examples.

FIG. 15 illustrates a user interface presenting aspects of the present disclosure, according to some examples.

FIG. 16 illustrates a user interface presenting aspects of the present disclosure, according to some examples.

FIG. 17 illustrates a user interface presenting aspects of the present disclosure, according to some examples.

FIG. 18 is a block diagram illustrating a document assistant system, according to some examples.

FIG. 19 is a block diagram illustrating aspects of the present disclosure, according to some examples.

FIG. 20 is a flowchart of a method for summarizing clauses in a legal document, according to some examples.

FIG. 21 is a flowchart of a method for summarizing clauses in a legal document, according to some examples.

FIG. 22 is a flowchart of a method for processing a legal document for analysis and summarization, according to some examples.

FIG. 23 is a flowchart of a method for generating question-and-answer data for a legal document, according to some examples.

FIG. 24 is a flowchart of a method for generating a user interface for document analysis and summarization, according to some examples.

FIG. 25 is a flowchart of a method for parallel processing of document segments for analysis and summarization, according to some examples.

FIG. 26 is a diagrammatic representation of a networked environment in which the present disclosure may be deployed, in accordance with some examples.

FIG. 27 is a diagrammatic representation of a processing environment, in accordance with some examples.

FIG. 28 is a block diagram showing a software architecture within which the present disclosure may be implemented, according to some examples.

FIG. 29 is a diagrammatic representation of a machine in the form of a computer system within which a set of instructions may be executed for causing the machine to perform any one or more of the methodologies discussed herein, in accordance with some examples.

### DETAILED DESCRIPTION

Legal documents contain complex language that can obscure critical details needed to make informed decisions. However, thoroughly reviewing the lengthy, nuanced terminology in these documents requires extensive manual effort. There is a need for technical solutions that can aid in rapidly extracting key information from legal documents and presenting it in a readily understandable format.

Recent advances in artificial intelligence provide capabilities in natural language processing that can be applied to parse legal language automatically. Some examples of systems based on machine learning algorithms and neural networks that are trained to analyze the text of legal documents are described herein. This analysis can identify and extract important details such as party names, dates, liabilities, and payment terms.

According to some examples, various techniques are leveraged to generate different representations of the key information. A high-level summary may recap the overall purpose and scope of the agreement. Individual sections and clauses may be summarized in more detail. Question and answer formats may anticipate common queries about legal documents and provide plain language explanations.

By programmatically identifying key information and transforming it into more accessible formats, users can rapidly pinpoint critical contract details. This reduces the burden of exhaustive manual review. Presenting details as summaries and a question/answer section can lower the risk of misinterpretation of complex legal wording. Users can more readily determine aspects requiring clarification, enabling more productive professional consultations.

Automated extraction and transformation of key information into simplified formats enhances transparency and understanding for users. More informed contract reviews and decisions become feasible as machine learning systems help unravel dense legal language into actionable insights.

These techniques are integrated into various workflows that guide users in reviewing and understanding legal documents. Within these workflows, key information is summarized and presented intuitively through user interfaces that provide the key information in various summarized formats to facilitate efficient access and understanding of the legal documents. Additionally, appropriate guardrails are implemented so that these machine learning systems are prevented from providing information that may be construed as legal advice.

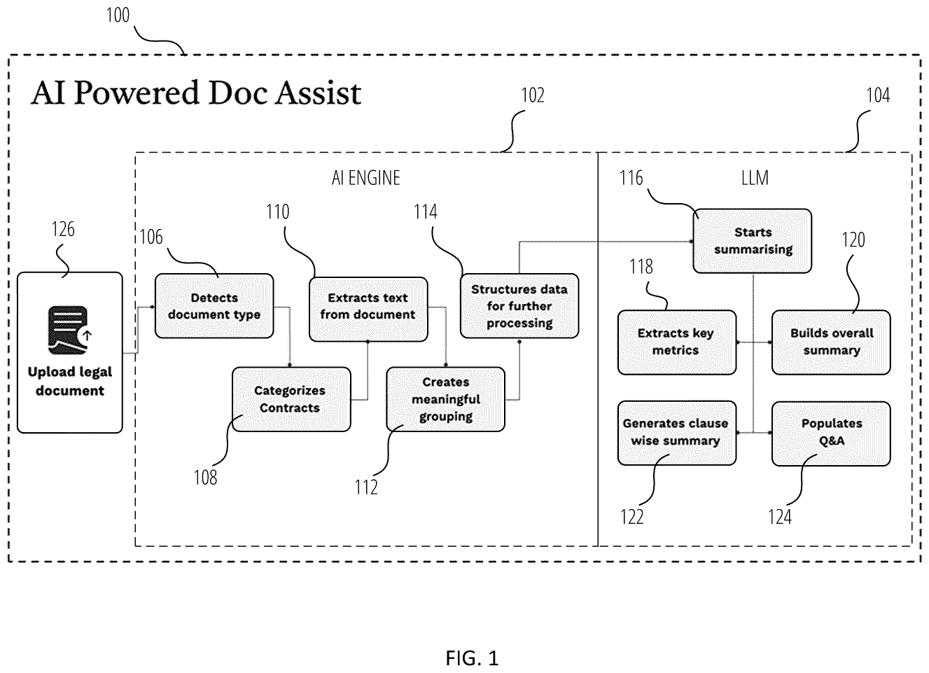

FIG. 1 is a block diagram showing a workflow of a document assistant system 100, according to some examples.

The document assistant system 100 includes a document processing module in the form of AI engine 102 for initial processing of an input document 126, and a summarization module in the example form of an LLM 104 for generating a summary and analysis of the processed document 126.

When an input document is received by the document assistant system 100, the AI engine 102 performs the following operations:

At operation 106, the AI engine 102 detects the document type of the input document 126. This detection involves determining whether the input document 126 is a legal document and, if so, what specific type of legal document it is (e.g., NDA, real estate contract). The AI engine 102 analyzes the structure, formatting, and textual content of the input document 126 to determine if it is a legal document, research paper, novel, etc. Machine learning algorithms may be used to categorize the document type based on training data using supervised learning techniques.

At operation 108, if the input document 126 is determined to be a legal document, AI engine 102 categorizes the specific type of document, such as a non-disclosure agreement, services agreement, real estate contract, etc. A database of different agreement types, and their standard sections and clauses, is referenced to match the sections present in the input document 126. In some examples, if the input document 126 is determined not to be a legal document (e.g., research paper, novel), the input document 126 is processed to generate a generic summary. In some examples, if the input document 126 is determined not to be a legal document, the input document 126 is flagged and prevented from further processing by the AI engine 102. A notification is generated to inform the user who uploaded the input document 126 that the input document 126 is not recognized as a legal document and cannot be processed.

At operation 110, textual content is extracted from the input document 126 through optical character recognition or other extraction techniques. This converts images and scanned documents into machine-readable text. Formatting and other non-textual elements may be removed during this conversion. In some examples, extracting text involves line detection and whitespace analysis to identify starts and ends of words, sentences, and paragraphs for segmenting the extracted text. Line detection involves analyzing the structure of the input document 126 to identify individual lines of text.

At operation 112, the extracted text is segmented or divided into meaningful groupings in order to facilitate downstream processing and analysis. This segmentation process enables the handling of large, complex documents that cannot be efficiently analyzed in their entirety.

Specifically, the extracted text is programmatically separated into logical segments using visual and textual cues within the document itself. These cues include formatting elements like headers, section breaks, changes in text formatting, as well as textual dividers like “Section 1”, “Article II” etc. The spacing and positioning of text may also be algorithmically analyzed to detect the start and end of paragraphs and other semantic blocks.

In some examples, the document assistant system 100 processes the extracted text segments by removing stop words to improve the efficiency and accuracy of the analysis. The stop word removal process involves filtering out common words (such as articles, prepositions, and conjunctions) that typically do not contribute meaningful content to the legal analysis. During text segmentation, the document is divided into paragraphs using regex patterns to identify possible end of line/heading patterns, and the document assistant system 100 applies stop word filtering to each segment. This preprocessing step helps focus the subsequent analysis on the substantive legal terms and concepts within each segment, enabling more precise classification and summarization of the contractual provisions. The filtered segments are then tracked and maintained to ensure the final summary generation incorporates all relevant legal content without omissions. This stop word removal technique enhances the ability of the document assistant system 100 to identify and categorize key contractual elements while maintaining the semantic integrity of the legal document.

This automated segmentation based on innate document structures and features enables large documents to be intelligently decomposed into smaller chunks that can be more readily processed by downstream algorithms. This allows summarization, analysis, and other techniques to be applied at the segment level in parallel across the input document 126, rather than having to process the entire document holistically in one pass.

For example, individual paragraphs can be simultaneously analyzed to identify the paragraph type or category using machine learning models. Related paragraphs can then be programmatically consolidated into topic-based composite segments to generate coherent summaries. Segmentation thereby provides the technical means to break down large documents into logical units that support improved parallelization, categorization, consolidation, and summarization compared to treating the document as a single monolithic text block.

Various natural language processing techniques may be used to implement the automated segmentation capability based on formatting and textual cues. This includes optical character recognition, text parsing, regular expressions, text boundary detection, whitespace analysis, and other algorithmic methods tailored to legal documents. Example implementations may leverage technologies like spaCy, OpenAI, and LangChain. according to some examples.

The example segmentation approach provides an objectively determinable, technically grounded solution to decompose large documents into logical segments by mimicking how humans visually parse documents. This facilitates scalable downstream analysis that would not be feasible on lengthy documents without segmentation.

In some examples, the document assistant system 100 encodes the segmented text using advanced natural language processing techniques to generate vector representations suitable for machine learning analysis. The encoding process leverages language models to transform each textual segment into a high-dimensional vector space that captures the semantic relationships between legal terms and concepts. For example, the document assistant system 100 utilizes specialized chains from LangChain, including AnalyzeDocumentChain and ConversationalRetrievalChain, to process the segments with configurable batch sizes optimized for different models. The vector representations enable efficient parallel processing of the segments, allowing the system to analyze multiple sections simultaneously while maintaining contextual relationships between related clauses. These encoded representations serve as inputs to various downstream tasks, including document classification, clause identification, and summary generation, enhancing the system's ability to understand and process complex legal documents with improved accuracy and efficiency.

At operation 114, the structured data is prepared for further processing by the AI engine 102. This can involve formatting the text, adding identifiers for each section, passing metadata, etc.

The LLM 104 then performs the following operations on the processed document:

At operation 116, the LLM 104 starts the process of summarizing the document 126 and extracting key information.

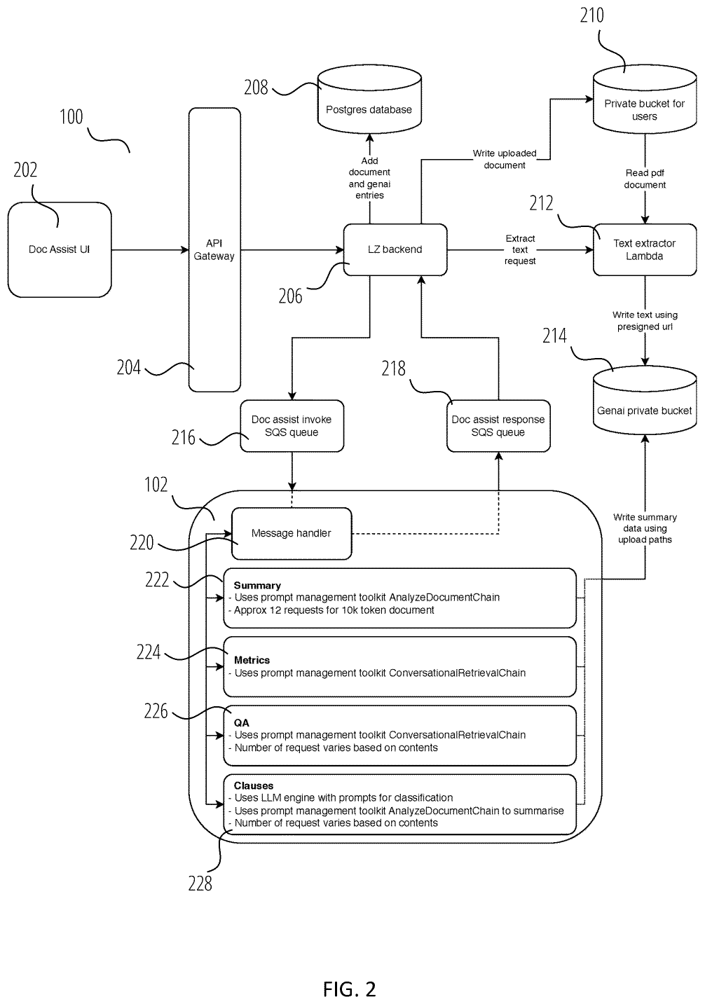

At operation 118, key metrics are extracted from the document 126, such as dates, dollar amounts, names, and numerical data. This data is identified and compiled into a structured format. In some examples, these metrics are extracted using the metrics engine 224 described below with reference to FIG. 2.

At operation 120, an overall summary of the document 126 is generated, providing a high-level overview of the document's purpose, key terms, and scope.

At operation 122, a clause-by-clause summary of the document 126 is generated for each major section of the document 126. Relevant clauses from different parts of the document 126 are consolidated into a cohesive summary for each contractual topic.

In some examples, the document assistant system 100 implements a multi-stage keyword extraction and comparison process to analyze clauses. For example, the document assistant system 100 employs specialized text splitters with configurable batch sizes to segment the document content. For each identified clause, the system extracts salient keywords and legal terms using natural language processing techniques. The extracted keywords are then processed through a classification engine that maps them to predefined section categories based on their legal context and significance. To facilitate comprehensive clause comparison, the document assistant system 100 employs parallel processing techniques to analyze multiple clauses simultaneously, enabling efficient identification of thematic relationships and common legal concepts across different sections of the document. The document assistant system 100 validates the extracted keywords and their classifications against a curated database of section references, ensuring accurate grouping and categorization of related contractual provisions. This systematic approach to keyword analysis enables the system to identify and consolidate semantically related clauses, even when they appear in non-sequential order within the document.

At operation 124, a question-and-answer section is populated by using the extracted information to preemptively generate FAQs and answers based on the agreement details.

Further details regarding the above operations, according to some examples, are provided below with reference to an architecture described with reference to FIG. 2

FIG. 2 is a block diagram illustrating an architecture of a document assistant system 100, according to some examples.

The document assistant system 100 comprises a system user interface (UI) 202 that allows users to interact with the document assistant system 100. Users can upload documents, view extracted information, and download output via the system user interface (UI) 202

An API gateway 204 receives requests from the system user interface (UI) 202 and routes them to a backend 206 that handles the core document processing logic. The backend 206 is implemented using a modular architecture that coordinates various document processing tasks.

A database 208 is coupled to the backend 206 and provides persistent storage of original document files, extracted text, and metadata such as document IDs and AI output. The database 208 allows efficient storage and querying of data as documents are processed.

The database 208 may store a mapping data structure, making the mapping data structure accessible to the backend 206. The database 208 may be implemented using technologies like MySQL, PostgreSQL, MongoDB, etc. to provide persistent storage and querying capabilities. The mapping data structure may consist of tables in the database 208 defining the relationship between document types and content categories:
A “document_types” table would contain rows for each supported document type, such as “Services Agreement”, “NDA”, “Lease Agreement”, etc.
A “content_categories” table would contain rows defining categories relevant to summarizing documents, such as “Parties”, “Term”, “Fees”, etc.
A “document_type_map” join table would link each document type row to related content category rows, creating the many-to-many relationship.

The backend 206 queries the database 208 to identify content categories for a given document type by joining the “document_types” and “document_type_map” tables. The identified content categories are passed to downstream engines and algorithms to customize the summarization for that document type.

Additional tables could store the mapping data structure, like defining sections within each content category.

This implementation allows the mapping data structure to be scaled, searched, and maintained efficiently while being leveraged by the backend 206 and algorithms to generate tailored summarization outputs.

Private object storage buckets (e.g., private buckets 210) are allocated on a per-user basis to provide secure, isolated storage of the extracted text and AI outputs for each user's documents. The backend 206 writes uploaded documents to the private buckets 210.

A text extractor Lambda 212 extracts plain text from uploaded documents and writes the extracted text to the private bucket 210 using temporary credentials per object upload.

An AI engine 102 leverages AI/LLM models such as GPT-3.5 and GPT-4 to analyze the extracted text. The AI engine 102 runs tasks such as text summarization engines 222, metrics engines 224, question-answering engines 226, and section processing engines 228 in parallel using prompts customized for each document type and task.

In some examples, the document assistant system 100 implements load balancing and model training techniques to optimize parallel processing of document segments. For example, the document assistant system 100 utilizes a message handler architecture that distributes processing tasks across available resources, with separate queues for document assist invocation and responses. For parallel processing of segments in batches, the document assistant system 100 employs multiple processing threads to simultaneously analyze document sections. Machine learning models utilized by the document assistant system 100 are trained using specialized chains from LangChain, including AnalyzeDocumentChain and ConversationalRetrievalChain, which process training segments with configurable batch sizes optimized for different model architectures. During operation, the document assistant system 100 dynamically allocates processing resources based on document complexity and size, with specific thresholds determining when to skip certain operations like clause identification for larger documents. This adaptive approach to resource allocation and model training enables efficient processing of legal documents while maintaining high accuracy in document analysis and summarization tasks.

The text summarization engine 222 generates a high-level overview of the document. The metrics engine 224 extracts key facts and figures. The question-answering engine 226 generates common questions and answers about the document. The section processing engine 228 identifies and summarizes individual clauses within the document by type.

The AI engine 102 stores outputs in a genAI private bucket 210. A message handler 220 coordinates sending documents to the AI engine 102 and processing the responses. Processed data is stored in the database 208 for later retrieval and display in the system user interface (UI) 202

An invoke SQS (Simple Queue Service) queue 216 and response SQS queue 218 allow asynchronous processing of documents using the AI engine 102. Together these components provide an intelligent automated document processing system using AI.

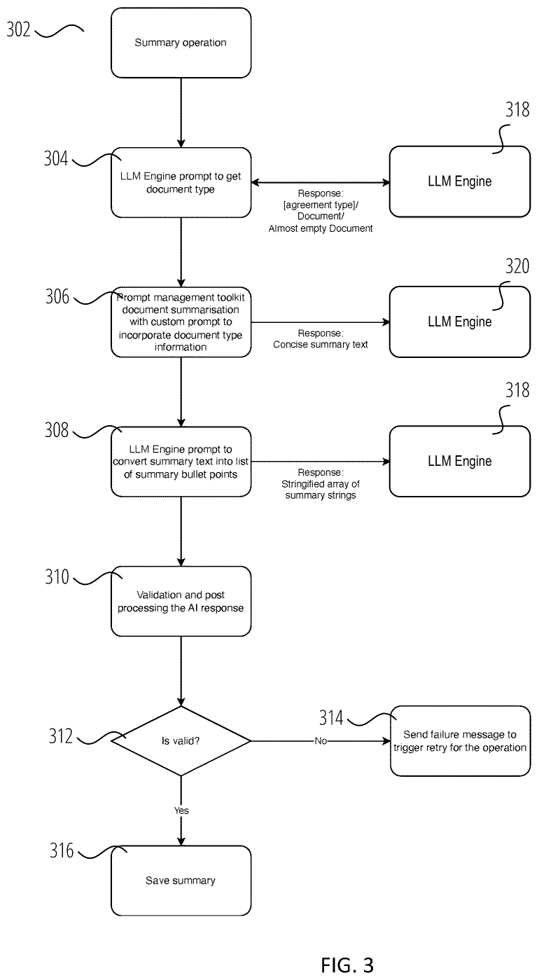

FIG. 3 illustrates a flowchart of a summarization operation 302 that may be performed by text summarization engines 222, according to some examples. Although the flowchart depicts a particular sequence of operations, the sequence may be altered without departing from the scope of the present disclosure. For example, some of the operations depicted may be performed in parallel or in a different sequence that does not materially affect functionality.

In some examples, a single LLM engine may be used by the summarization operation 302. In some examples, multiple, fine-tuned models may be used, such as:
A conversation LLM engine 318 in the example form of OpenAI model GPT-4
A text generation LLM engine 320 in the example form of OpenAI model text_davinci-003

In examples where multiple LLM engines are used, each of these engines may be fine-tuned and trained for a specific purpose or set of functions.

At operation 304, an LLM prompt is constructed and sent to the LLM engine 318 to identify the document type of the input document. The prompt is designed to ask the LLM engine 318 to analyze the input document and determine whether it is a legal document, research paper, novel, or some other document type. The prompt may be phrased to instruct the LLM engine 318 to respond with the detected document type, such as “[Agreement Type]/Document/Almost empty document,” where [Agreement Type] would be filled in with the specific type of legal document detected by the model, such as “NDA” or “Services Agreement”. If the document is determined not to be a legal document, the model responds with “Document” or “Almost empty document”. The LLM engine 318 analyzes the textual content, formatting, and structure of the input document 126 to categorize it into one of the defined document types per the instructions given in the prompt.

At operation 306, the plain text extracted from the input document is provided as input to a prompt management toolkit of the text summarization engine 222. This prompt management toolkit is customized by configuring it with a prompt that incorporates the document type identified by the LLM engine 318 in operation 304. For example, if the input document was categorized as a “Services Agreement”, the prompt may be constructed to summarize the key points of a services agreement. In some examples, the prompt management toolkit is a software solution designed to streamline the process of creating, iterating, debugging, and managing prompts for AI systems like large language models.

The prompt instructs a prompt management toolkit to generate a high-level generic overview summarizing the key terms, scope, and purpose of the input document, taking into account its identified document type.

The prompt management toolkit may use the LLM engine 320 to analyze the extracted text and produce the requested summary per the instructions in the prompt. The LLM engine 320 processes the input text and generates a summary response containing concise overarching points describing the document's purpose, key terms, parties involved, and scope. The response is returned in natural language as multiple sentences summarizing the essence of the input document based on its detected type. The LLM engine 320 is optimized for summarization tasks and can generate more natural language summaries compared to previous versions.

At operation 308, after the summary text is generated by the LLM engine 320 in operation 306, another prompt is constructed and sent to the LLM engine 318 for further processing of the summary. The objective of this prompt is to convert the free-form summary text into a list of concise bullet points highlighting the key information. The prompt is designed to instruct the LLM engine 318 to take the summary text as input and output bullet points capturing the essence of the summary.

For example, if the summary is:
“This services agreement between Company ABC and XYZ outlines the terms under which XYZ will provide IT support and maintenance services to ABC. The key points are a 12-month term at $5,000 per month, along with clauses specifying service levels, confidentiality, and termination conditions.”

The prompt may for example be phrased to generate the following response:
12-month term at $5,000 per month
XYZ to provide IT support and maintenance to ABC
Service levels defined
Confidentiality terms
Termination conditions specified

The LLM engine 318 analyzes the content of the summary text to identify the salient points and convert those into concise bullet point statements based on the instructions provided in the prompt. The response contains the key extracted information from the summary transformed into a scannable bulleted list format.

At operation 310, the output generated by the AI models undergoes validation and post-processing before it is finalized. This stage acts as a quality check to ensure the accuracy and relevance of the AI-generated summary, as well as reformat it into a polished end product.

The validation involves techniques may include, for example:
Checking for any factual inconsistencies between the summary and the original document.
Verifying key dates, names, and numbers match the source material.
Evaluating the clarity, conciseness, and logical flow of the summary.
Confirming the summary incorporates the pertinent details for its identified document type.
Assessing the grammar, spelling, and readability of the summary text.

If any errors or inconsistencies are identified, the summary text may be sent back to the AI models for re-generation.

Post-processing techniques may include:
Removing redundant or repetitive sentences.
Formatting the text into coherent paragraphs.
Adding headings, lists, or other structural elements as needed.
Standardizing entity names and dates.
Smoothing transitions between ideas and concepts.
Simplifying complex sentence structures for readability.
Extracting and structuring tabular data and similar structures by making sense of rows and columns.

The end result is a polished, validated summary response that accurately captures the key information from the source or input document 126 in a clear and concise format tailored to its document type.

At decision operation 312, the AI-generated summary content that has been post-processed and validated goes through an additional decision point.

The response is evaluated based on criteria such as:
. Does it accurately reflect the key points of the source document?
Is the length appropriate for a high-level summary?
Does it contain unnecessary details or repetitive information?
Is the language clear and easy to understand?
Does it conform to the desired summary structure and formatting?

If the response fails to meet the expected quality standards for a summary, it is deemed invalid. At operation 314, if the response is invalid, a failure message is automatically sent to trigger a retry of the summarization operation. This prompts the AI models to re-generate the summary content. The same validation checks are then re-applied to the new output in an iterative process until a valid response is produced.

Once a response passes all validation criteria and is deemed a valid summary, operation 316 saves the AI-generated text as the final output of the summarization operation. This output summary is then available for downstream uses such as inclusion in the final document analysis results presented to the user. The outputs may be in a searchable format.

In some examples, an iterative validation and regeneration process is used to ensure the accuracy and quality of generated summaries. Validation checks are applied to generated summaries using predefined criteria to verify the completeness and accuracy of the summaries. When validation checks fail, a failure message is triggered that initiates an automated retry operation for the specific processing step. The validation process examines both the structural integrity and semantic content of the generated summaries, with separate validation steps for highlights, clause summaries, and overall document summaries. For failed validations, custom prompts and specialized chains may be employed to regenerate the summaries, incorporating feedback from the failed validation checks to improve subsequent generation attempts. This iterative approach continues until the generated summaries meet the predefined validation criteria, ensuring consistent quality and accuracy in the final output. Furthermore, by maintaining tracking of filtered and processed text throughout the regeneration cycles, relevant legal content is preserved during the iterative refinement process.

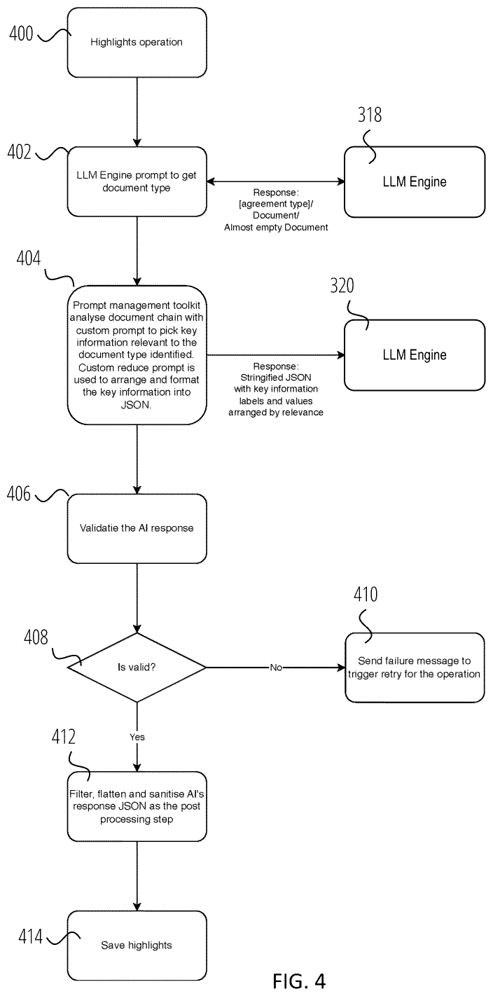

FIG. 4 illustrates a flowchart of a highlight generation operation 400 that may be performed by the AI engine 102, according to some examples. Although the flowchart depicts a particular sequence of operations, the sequence may be altered without departing from the scope of the present disclosure. For example, some of the operations depicted may be performed in parallel or in a different sequence that does not materially affect functionality.

At operation 402, an LLM prompt is constructed and provided to the LLM engine 318 to identify the document type of the input document. The prompt is designed to analyze the document and categorize it into a defined document type such as a legal agreement, research paper, etc. For example, an input document may be categorized as a legal document or not a legal document. An input document that is categorized as not a legal document (e.g., research paper, resume, ebook) may be prevented from further processing. An input document categorized as a legal document may be further categorized based on different types of legal documents (e.g., lease agreement, security agreement, employment agreement, non-disclosure agreement, power of attorney, operating agreement, personal services agreement, operation agreement, legal notices, promissory notices)

The LLM engine 318 processes the document text and formatting and responds with the detected document type. The prompt may be phrased to instruct the LLM engine 318 to respond with the detected document type, such as “[Agreement Type]/Document/Almost empty document,” where [Agreement Type] would be filled in with the specific type of legal agreement detected by the model, such as “NDA” or “Services Agreement”. If the document is determined not to be a legal document (e.g., an agreement or contract), the model responds with “Document” or “Almost empty document”. The LLM engine 318 analyzes the textual content, formatting, and structure of the input document 126 to categorize it into one of the defined document types per the instructions given in the prompt.

At operation 404, the plain text of the input document 126 is provided to a prompt management toolkit (e.g., a custom toolkit, a LangChain module etc.) of the AI engine 102, which is customized with a prompt incorporating the identified document type from operation 402. The prompt instructs the prompt management toolkit to extract and format key information from the document into a JSON structure or other structured format, arranging the data by relevance based on the document type. In some examples, a pipeline may be implemented by the prompt management toolkit specifically for the highlight generation task, chaining together the following components:
A text splitter to break the document text into chunks of 5000 tokens or less. This allows the large language models to process the text in batches.
A conversational retrieval module using the LLM engine 318. This module takes each text chunk and generates key information relevant to the document type identified by the LLM engine 318 in operation 402.
The prompt provided to the conversational retrieval module is customized to extract important details for the specific document type. For example, for a services agreement, it may extract parties, dates, payment terms, etc.
A reduce module that takes the output from the conversational retrieval across all text chunks and organizes it into a structured JSON format.
The reduce prompt may be designed to arrange the information into logical JSON fields and rank it by relevance. Dates, names, and monetary values are prioritized.
Additional code filters the JSON to remove duplicates, standardize entities, and refine the data structure.

The final output is a JSON object containing the salient entities and facts extracted from the full document text, formatted and structured optimally for downstream consumption.

At operation 406, the output generated by the LLM engine 320 undergoes validation to ensure accuracy and relevance. Validation techniques may include verifying entities match the source text, assessing length and structure, and checking for errors. Validity may be evaluated based on criteria such as accuracy, relevance, and formatting, for example. Examples of criteria that may be used to validate the AI output in operation 406 include:
Accuracy—Checking that entities, dates, names, and facts extracted by the AI match the source document text.
Relevance—Assessing whether the highlighted information is relevant and important to understanding the gist of the document, based on its detected type. Less relevant details are filtered out.
Completeness—Verifying that key pieces of information are captured and not omitted. Cross-referencing against fields known to be critical for that document type.
Structure—Validating that the output is formatted properly as a JSON object with logical organization of entities under relevant fields.
Duplication—Checking for duplicate facts/entries and removing any redundancies.
Length—Ensuring the output is a reasonable length and level of detail for highlights, not too long or short.
Errors—Looking for any obvious AI hallucinations, unrelated text, or other errors that should be removed.
Readability—Assessing clarity, spelling, and grammar to ensure highlights are coherent.
Consistency—Validating uniformity of entities/formatting across the extracted facts.

At decision operation 408, if the response is invalid, the highlight generation operation 400 proceeds to operation 410 where a failure message is sent to trigger the re-generation of the highlights.

If the response is valid, operation 412 performs post-processing such as filtering, flattening, and sanitizing the JSON output from LangChain into the final desired structure. The goal is to ensure the AI output contains succinct, accurate, and relevant key facts about the document, structured to feed into downstream processes.

Finally, at operation 414, the processed highlight data is saved as the output of the highlight generation operation 400.

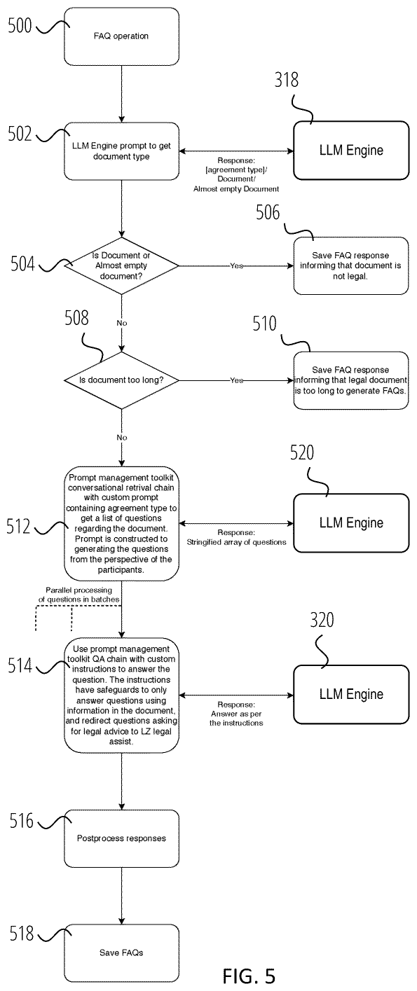

FIG. 5 is a flowchart of a FAQ operation 500 that may be performed by a question-answering engine 226 of the AI engine 102, according to some examples. In some examples, in addition to using LLM engine 318 and LLM engine 320, the FAQ operation 500 may also use a third LLM engine, namely an LLM engine 520 (e.g., OpenAI model GPT 3.5-turbo). Although the flowchart depicts a particular sequence of operations, the sequence may be altered without departing from the scope of the present disclosure. For example, some of the operations depicted may be performed in parallel or in a different sequence that does not materially affect functionality.

At operation 502, an LLM prompt is constructed and sent to the LLM engine 318. The prompt is designed to analyze the document and respond with the detected document type, such as “[Agreement Type]/Document/Almost empty Document,” where [Agreement Type] is the specific type identified. The LLM engine 318 analyzes the text to categorize the document type.

At decision operation 504, a determination is made as to whether the response is “Document” or “Almost empty Document”, indicating that the document is not a legal document, such as a contract or agreement.

Following a positive determination at decision operation 504, at operation 506, a response is saved informing the user that the document is not a legal document and FAQs cannot be generated.

Following a negative determination at decision operation 504, at decision operation 508, if the document is a legal document (e.g., a contract or agreement), a check is made of the document length. If the document length exceeds a predetermined length threshold, it is deemed too long. If so, at operation 510, a response is saved informing the user that the legal document exceeds the size limit for generating FAQs.

On the other hand, if the document is determined not to be too long at decision operation 508, the FAQ operation 500 proceeds to operation 512. A conversational retrieval module (of the prompt management toolkit) is initialized and configured with a custom prompt that incorporates the agreement type identified by the LLM engine 318 in operation 502. For example, if the document was classified as a “Services Agreement”, the prompt may contain language such as: “Generate a list of questions one might ask about a Services Agreement between Company ABC and XYZ. Ask from the perspective of both parties involved in the agreement.”

This instructs a natural language model (e.g., LLM engine 520) to analyze a services agreement and produce common questions that the participants may need to have answered to understand the terms and implications of that agreement. The prompt containing the context of the agreement type is provided as input to the LLM engine 520. The LLM engine 520 may be an optimized version of GPT-3 specialized for conversational tasks. The LLM engine 520 processes the instructions in the prompt and generates a list of relevant questions based on its analysis of what questions would commonly arise for that document type.

The output is a stringified array containing multiple questions generated by the LLM engine 520 about the agreement, phrased from the point of view of the participants involved. This array of questions may then be used as input for the downstream FAQ operation 500. The custom prompt to LLM engine 520 provides tailored, contextual questions for the specific document.

At operation 514, the array of questions generated is processed in parallel batches using a question-answering (QA) chain module (e.g., of the prompt management toolkit). This QA chain module may be instantiated with custom instructions tailored for the legal document FAQ use case. The instructions indicate that answers may be generated by extracting information from the content of the input document 126. This seeks to prevent the LLM engine 320 from relying on outside knowledge. Additionally, the instructions specify that questions seeking legal advice or opinions should not be answered directly. For these types of questions, the LLM engine 320 may be directed to respond with a statement redirecting the user to seek assistance from a qualified legal professional. In some examples, the statement includes a selectable element to initiate a workflow for communicating with a qualified legal professional.

For other questions, the LLM engine 320 is used to analyze the input question and document text to produce an answer based on relevant facts from the document. The LLM engine 320 may optimized for complex instruction-following, which enables it to generate high-quality answers adhering to the guidelines provided in the prompt. The parallel processing batches allow multiple questions to be answered simultaneously, improving throughput. The customized instructions constrain the models to only use approved sources when generating answers and validating the output.

At operation 516, post-processing is done on the responses to sanitize and validate the content.

At operation 518, the final FAQ output is saved after this post-processing operation.

In some examples, the question-answering engine 226 of the AI engine 102 applies the principles described above with respect to generating answers to questions provided by a user in a conversational context (e.g., chat). Here, each question provided by the user is processed to, for example, determine whether the question is seeking legal advice or opinions that should not be provided directly without oversight by a qualified legal professional. In response to such questions, a selectable element to initiate a workflow for communicating with a qualified legal professional may be provided.

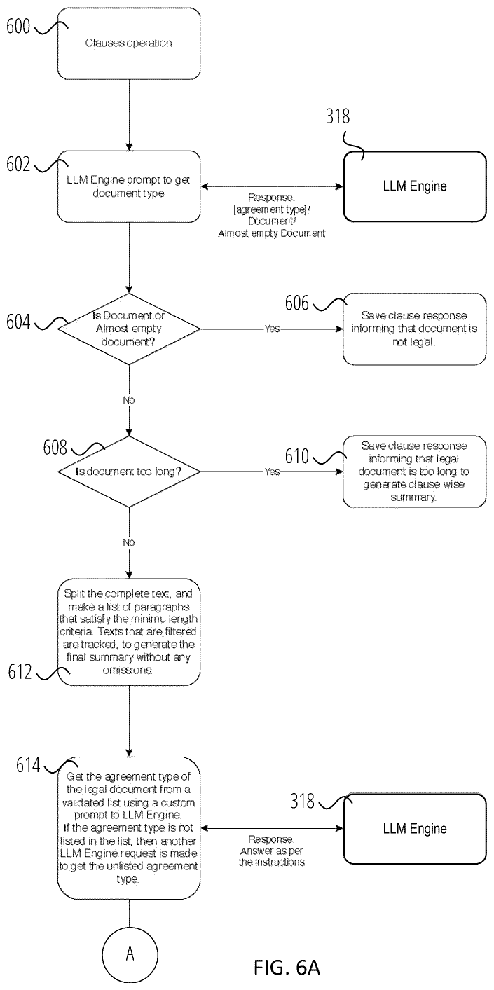

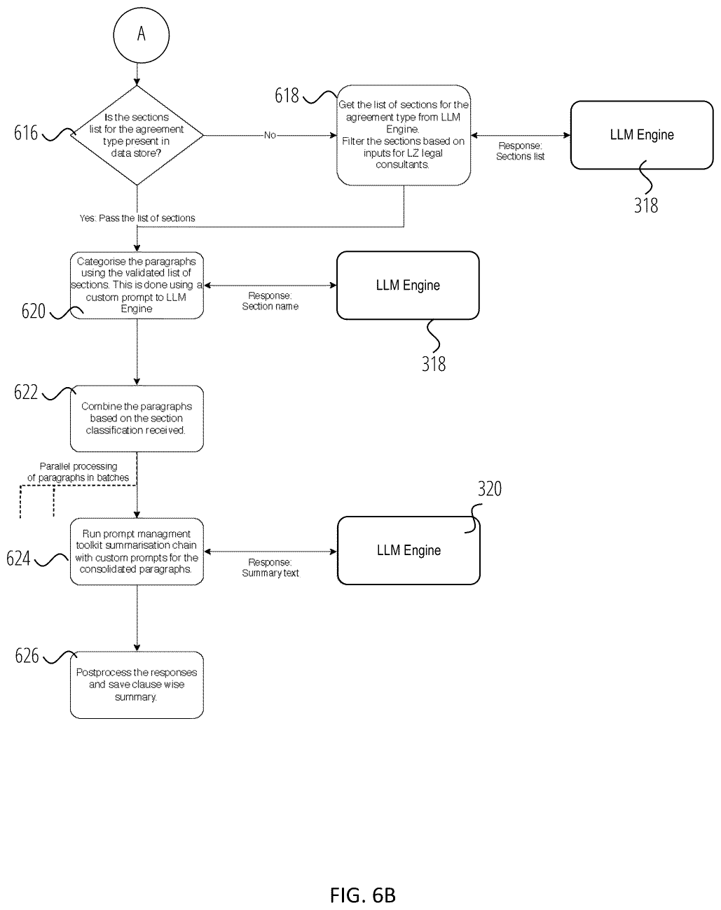

FIG. 6A and FIG. 6B illustrate a flowchart that shows the sub-operations within a clauses operation 600, based on examples provided by the section processing engine 228 of the AI engine 102. Although the flowchart depicts a particular sequence of operations, the sequence may be altered without departing from the scope of the present disclosure. For example, some of the operations depicted may be performed in parallel or in a different sequence that does not materially affect functionality.

The clauses operation 600 starts at operation 602, where the LLM engine 318 is prompted to obtain a document type. The LLM engine 318 responds with (1) an agreement type (e.g., based on the LLM engine 318 being able to successfully identify an agreement type), (2) document or (3) an almost empty document.

At decision operation 604, a determination is made by the AI engine 102 as to whether the response from the LLM engine 318 indicated a document or almost empty document-in other words, that the input document 126 is one or the other.

If the document is determined to be an almost empty document, the clauses operation 600 moves to operation 606. Here, a clause response is saved, recording that the document is not a legal document.

If the document is determined to be a legal document at decision operation 604, the clauses operation 600 moves to decision operation 608. Here, a determination is made about the length of the document, specifically whether it is too long.

If it is determined that the document is too long at decision operation 608, the clauses operation 600 moves to operation 610. Here, a clause response is saved, recording that the legal document is too long to generate a clause summary.

On the other hand, if the document is not deemed to be too long at decision operation 608, the clauses operation 600 moves to operation 612. At operation 612, the input document 126, for example, the complete text of the document, is split and a list of paragraphs is generated that meet a predetermined minimum length requirement. The text is further filtered, with the tracking of such filtering, to create a final summary without any omissions to the input document 126.

At operation 614 the AI engine 102 prompts the LLM engine 318 to obtain the agreement type of the input document 126. In some examples, the LLM engine 318 is initially requested for a specific agreement type, from a list of validated agreement types. This list is included in a custom prompt given to the LLM engine 318.

If the agreement type identified by the LLM engine 318 is contained in the validated list, that agreement type is used. However, if the LLM engine 318 identifies an agreement type not present in the validated list, the AI engine 102 makes an additional request to the LLM engine 318 to obtain the unlisted agreement type.

Moving now to FIG. 6B, at decision operation 616, the AI engine 102 checks if there is a mapping data structure, such as a sections list, for the agreement type stored in the database 208. This mapping data structure assigns content categories to different agreement or contract types.

If no mapping data structure is found for the agreement type, the AI engine 102 proceeds to operation 618. Here, it obtains a list of contract or agreement sections for the relevant agreement type from the LLM engines 318. This list is filtered either through manual review by system operators or through an automated process.

On the other hand, if there is a sections list or after the completion of operation 618, the clauses operation 600 moves to operation 620. Here, the AI engine 102 categorizes paragraphs of the input document 126 using the validated list of sections specific to the agreement type. This categorization may be done through a custom prompt provided by the AI engine 102 to the LLM engine 318 to retrieve section names.

Once the paragraphs are categorized in operation 620, the AI engine 102 combines (e.g., concatenates) them based on the assigned classification or category of the relevant sections at operation 622.

The clauses operation 600 then proceeds to operation 624, where the AI engine 102 runs a summarization chain (of the prompt management toolkit) with custom prompts for the consolidated paragraphs. This is performed using the LLM engine 320 by sending prompts and receiving summary text as responses.

After operation 624, the responses are post-processed at operation 626, and a summary of the clauses is saved in the database 208 on a clause-by-clause basis.

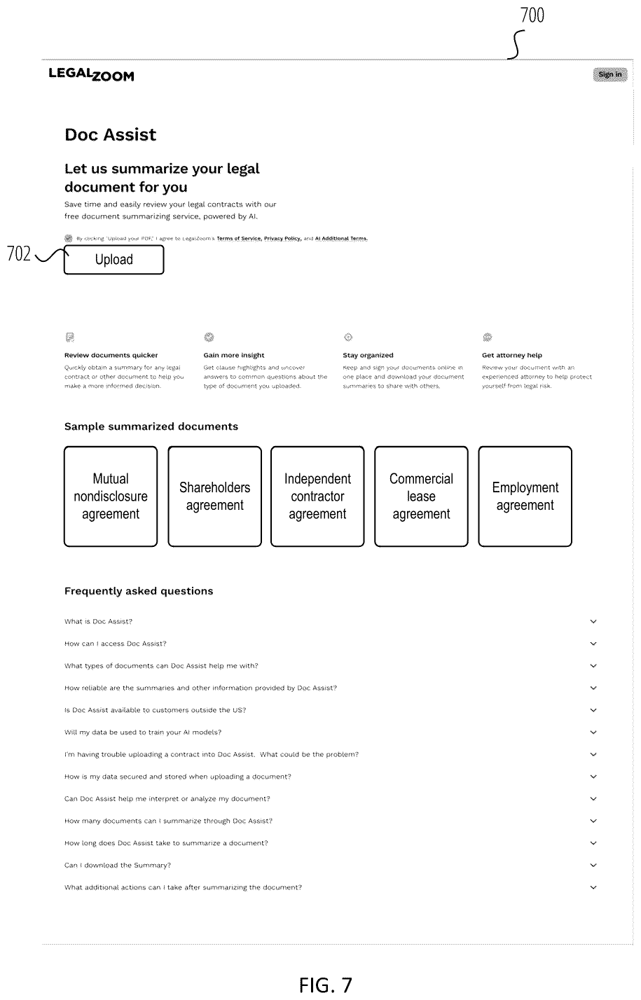

FIG. 7 is a user interface diagram showing a landing page 700, according to some examples, generated by the API gateway 204 as part of the system user interface (UI) 202. The landing page 700 facilitates the initiation of various workflows, including summarization operations, highlight generation operations, FAQ operations, clauses operations, and other workflows provided by the document assistant system 100. The landing page 700 includes an “Upload” button 702 which allows users to upload an input document 126 to the document assistant system 100. In some examples, the various workflows provided by the document assistant system 100 are initiated in response to upload of the input document 126.

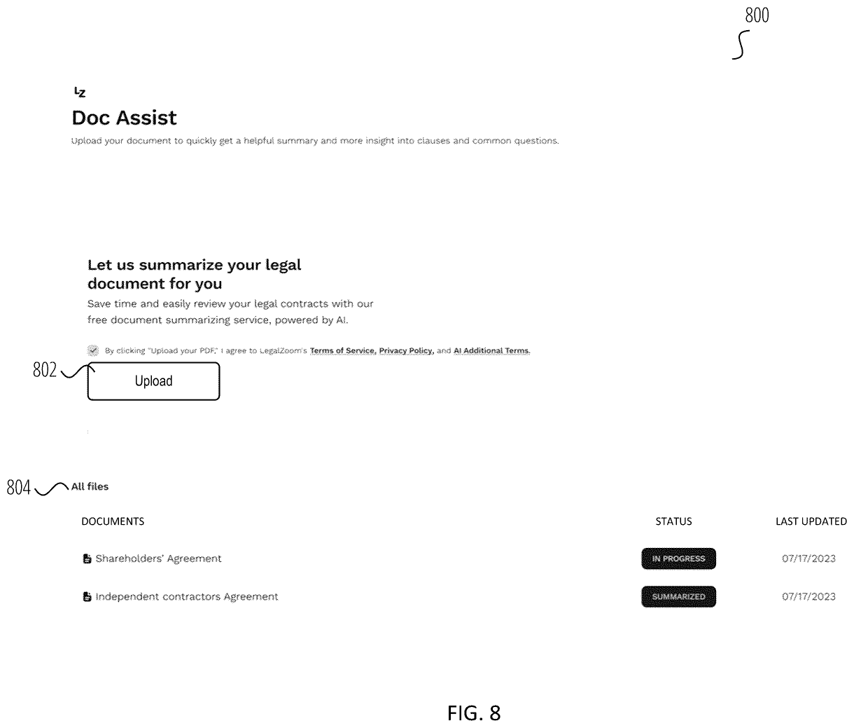

FIG. 8 is a user interface diagram showing an asset page 800, according to some examples, generated as part of the system user interface (UI) 202. The asset page 800 includes an “Upload” button 802 for uploading documents to the system. Additionally, the asset page 800 has a file list section 804 that displays agreements uploaded by users for analysis and summarization. Each file in the list is accompanied by a document title, a processing status, and the date it was last updated. As illustrated in FIG. 8, the asset page 800 identifies uploaded documents for which summarization operations are in progress and uploaded documents for which summarization operations are complete. Each file in the file list section 804 is a selectable element providing access to the file and corresponding materials generated by the document assistant system 100.

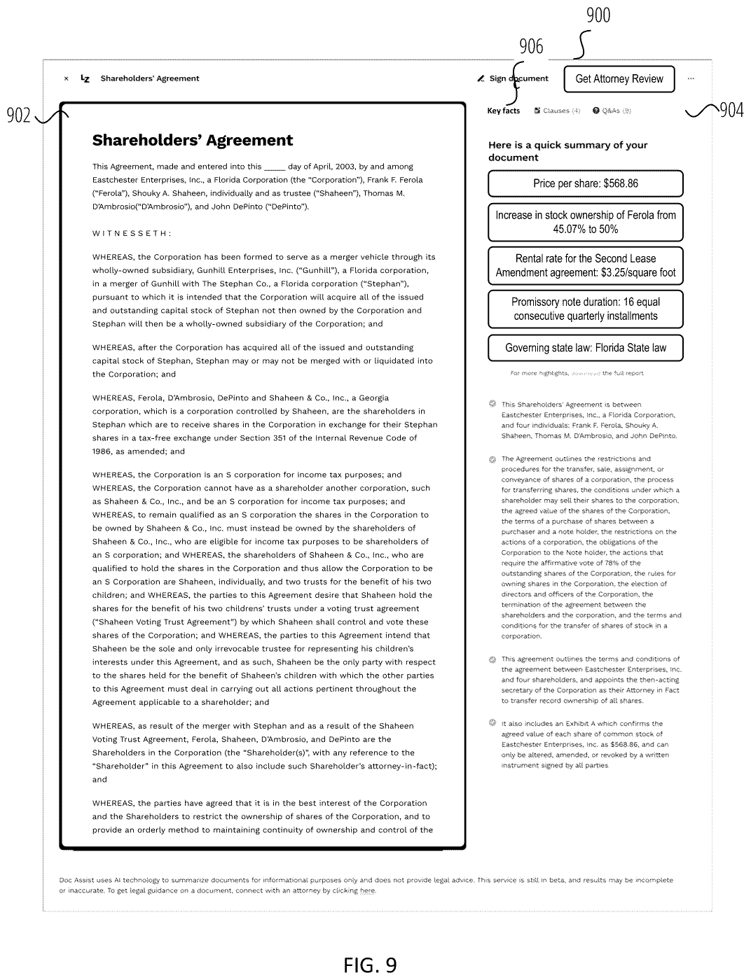

FIG. 9 is a user interface diagram showing a summary page 900, according to some examples. The summary page 900 includes a document section 902 on the left-hand side that displays the full text of an uploaded document, such as a shareholder's agreement.

On the right-hand side of the interface, there is an analysis panel 904 with three tabs: “Key Facts,” “Clauses,” and “Question and Answer.” In this example, the “Key Facts” tab 906 is active and displays summary data generated by the text summarization engine 222. The top portion of the analysis section 904 presents key facts in cards, such as price per share data, increase in stock ownership data, rental rate for second lease amendment agreement data, promissory note duration data, and governing state law data. The specific summary facts displayed can vary depending on the type of agreement and the assessed key facts. Below the key facts cards, various summaries of sections or content of the document are displayed. In some examples, the key facts cards are selectable elements that facilitate navigation of the document section 902. Selection of a key fact card causes the document section 902 to navigate to a portion of the uploaded document that is related to the selected key facts card.

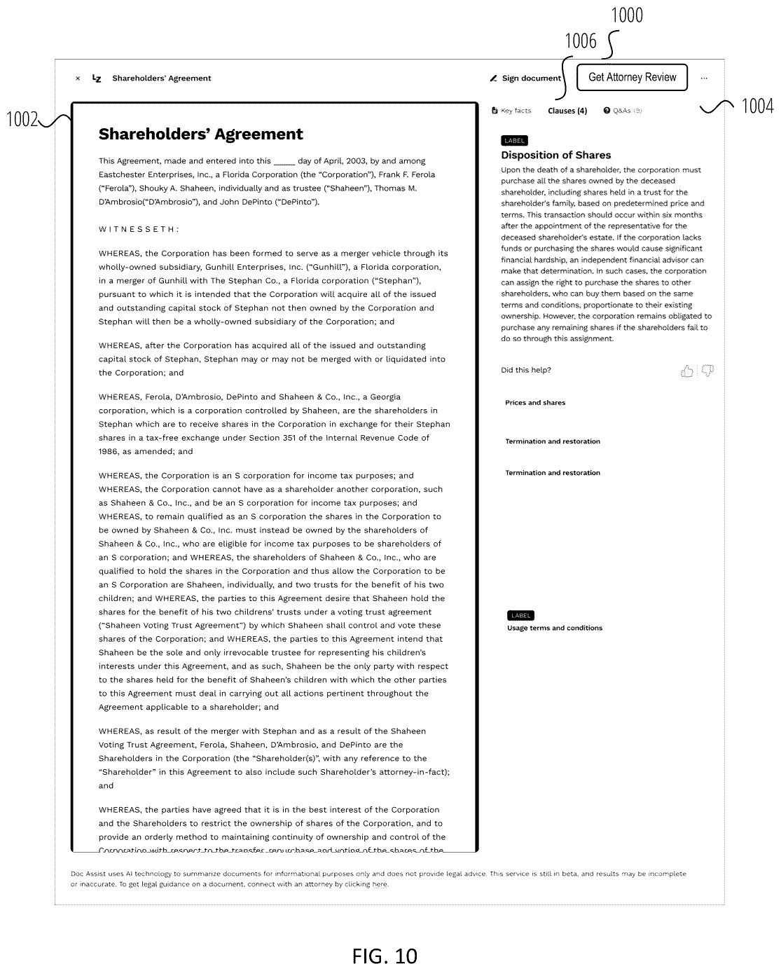

FIG. 10 is a user interface diagram showing a clauses page 1000, according to some examples. The clauses page 1000 is generated when the user selects the “Clauses” tab 1006 within the analysis section 1004 of the interface. The agreement text persists in the document section 1002, while the analysis section 1004 presents a clause analysis. Labels associated with specific clauses are displayed, and user selection of a label expands a summary description of the relevant clauses. For example, in response to a selection of the label “Disposition of Shares,” a corresponding section of the analysis section 1004 is expanded, presenting a summary description of the disposition of shares. In some examples, selection of the label also causes the document section 1002 to navigate to a portion of the uploaded document that is related to the selected label.

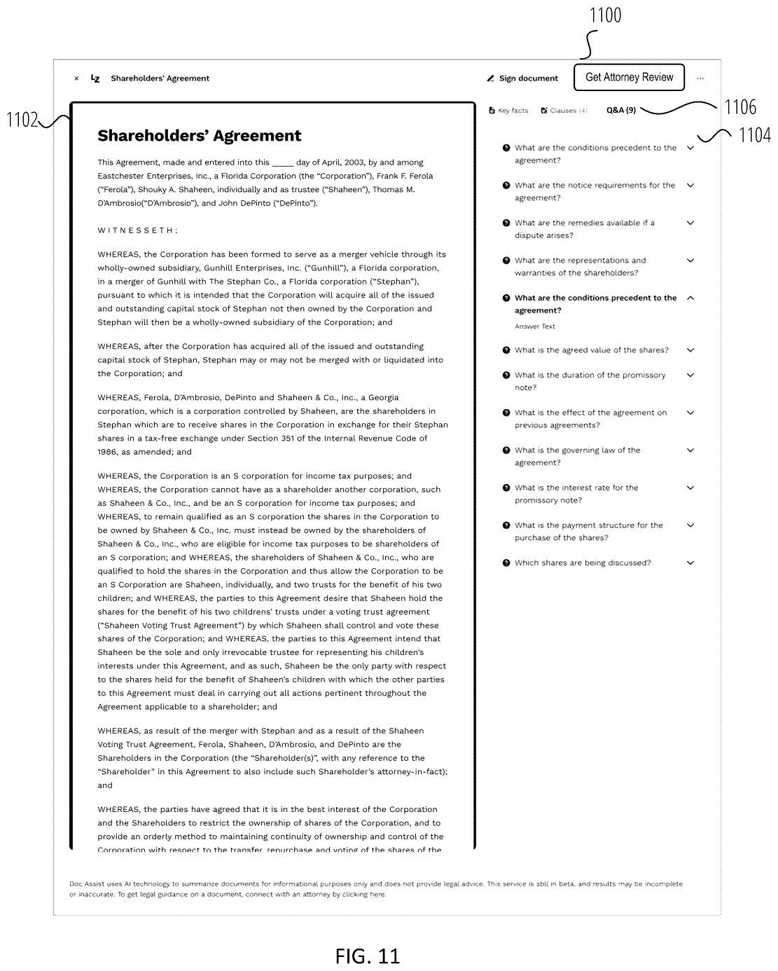

FIG. 11 is a user interface diagram showing an FAQ page 1100, according to some examples. The FAQ page 1100 is displayed when the user selects the “Question and Answer” tab 1106 within the analysis section 1104. The document text, in this case, the shareholder agreement, remains in the document section 1102. The analysis section 1104 displays a list of questions and answers (FAQs). Each question has a downward caret that can be clicked to reveal the corresponding answer. For example, in response to a selection of a question “What are the conditions precedent to the agreement?” a corresponding section of the analysis section 1104 expands to display an answer corresponding to the selected question. In some examples, selection of the question also causes the document section 1102 to navigate to a portion of the uploaded document that is related to the selected question.

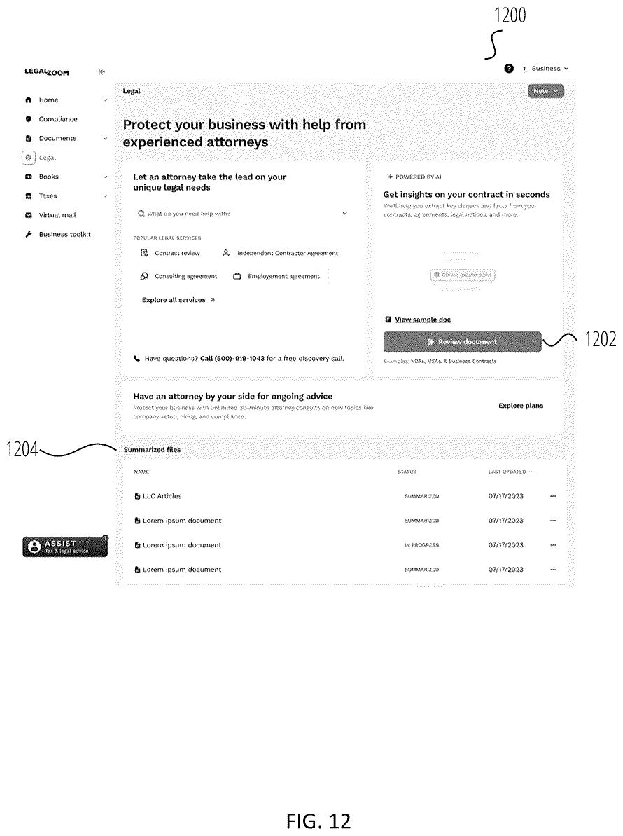

FIG. 12 is a user interface diagram showing a navigation page 1200, according to some examples, generated as part of the system user interface (UI) 202. The navigation page 1200 facilitates the initiation of various workflows provided by the document assistant system 100. Additionally, the navigation page 1200 provides access to materials previously generated by the document assistant system 100. The navigation page 1200 includes a “Review document” button 1202 which allows users to upload a document or select from a previously uploaded document. For example, a user may select the button 1202 and select a previously uploaded document for a summarization operation by the document assistant system 100. Additionally, the navigation page 1200 has a summarized file list section 1204 that displays documents uploaded by users for analysis and summarization. Each document in the summarized file list section 1204 corresponding materials generated by the document assistant system 100. Each document in the summarized file list section 1204 is a selectable element that provides access to the corresponding materials.

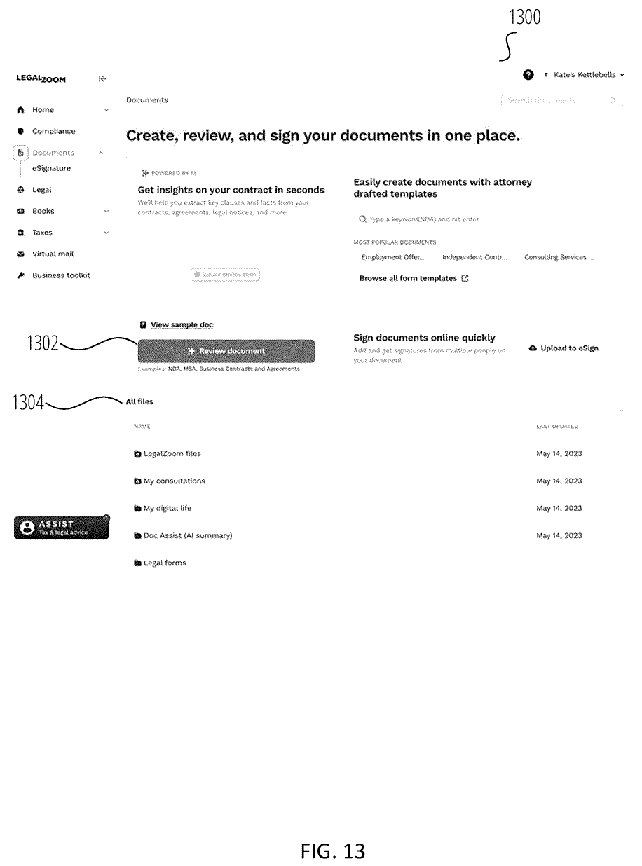

FIG. 13 is a user interface diagram showing a navigation page 1300, according to some examples, generated as part of the system user interface (UI) 202. The navigation page 1300 facilitates the initiation of various workflows provided by the document assistant system 100. Additionally, the navigation page 1300 provides access to previously uploaded documents. The navigation page 1300 includes a “Review document” button 1302 which allows users to upload a document or select from a previously uploaded document. For example, a user may select the button 1302 and upload a document for a summarization operation by the document assistant system 100. Additionally, the navigation page 1300 has an all files list section 1304 that displays all documents uploaded by users. A user may select a document from the all files list section 1304 to, for example, initiate a summarization operation or other operation facilitated by the document assistant system 100. In some examples, the document assistant system 100 detects documents that are not legal documents and declines to provide analysis and summarization operations for these documents. Each document in the all files list section 1304 is a selectable element to facilitate navigation to an uploaded file. Selection of a non-legal document causes presentation of a notification indicating that analysis and summarization operations are not available for the non-legal document.

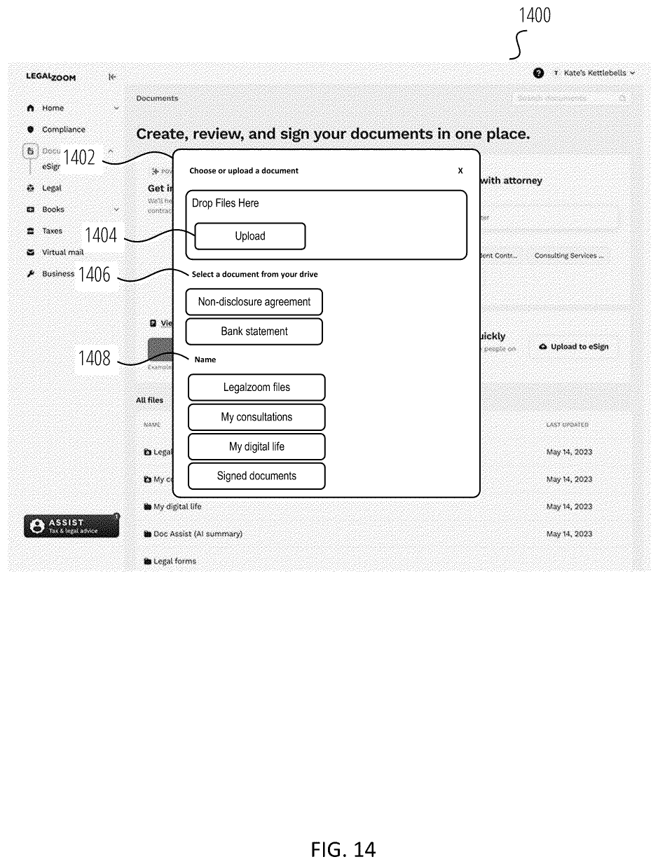

FIG. 14 is a user interface diagram showing an upload modal page 1400, according to some examples, generated as part of the system user interface (UI) 202. The upload modal page 1400 may be presented in response to selection of the “Review document” button 1202 of FIG. 12 or the “Review document” button 1302 of FIG. 13. As illustrated in FIG. 14, the upload modal page 1400 includes an upload modal 1402 that facilitates upload of a document and navigation of uploaded documents. The upload modal 1402 includes an “Upload” button 1404 which allows users to upload a document. The upload modal 1402 includes a recent files section 1406 that lists documents with which a user has recently interacted and documents the user has recently uploaded. The upload modal 1402 includes an all files list section 1408 that displays all uploaded documents. Selection of a document from the recent files section 1406 or the all files section 1408 initiates analysis and summarization of the selected document by the document assistant system 100. In some examples, selection of a non-legal document from the recent files section 1406 or the all files section 1408 causes presentation of a notification indicating that analysis and summarization operations are not available for the selected document.

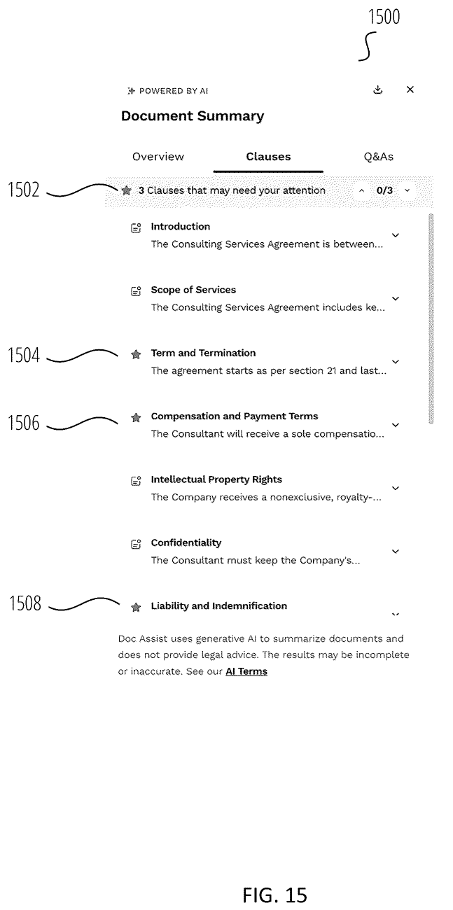

FIG. 15 is a user interface diagram showing a clauses section 1500, according to some examples. In some examples, the clauses section 1500 may be presented on the clauses page 1000 of FIG. 10. As illustrated in FIG. 15, the clauses section 1500 includes a listing of labels associated with specific clauses of an analyzed and summarized document. User selection of a label expands a summary description of a clause corresponding with the label. For example, in response to a selection of the label “Introduction,” a corresponding section of the clauses section 1500 is expanded to present a summary description of the introduction of an analyzed and summarized document.

The clauses section 1500 includes a notification section 1502 that indicates a number of clauses (e.g., three) that are flagged as potentially being important and in need of further attention. Each flagged clause has a corresponding label with an identifier (e.g., star) to indicate the clause is flagged. The clauses may be flagged based on the clauses being associated with metrics that are outside a threshold range of typical values for the metrics. The clauses may be flagged based on the clauses being identified as important clauses for the type of document associated with the uploaded document. For example, the “Term and Termination” label 1504 and the “Compensation and Payment Terms” label 1506 correspond with clauses that are flagged based on these clauses being important clauses for the type of document (e.g., service agreement). The “Liability and Indemnification” label 1508 corresponds with a clause that may be flagged based on values (e.g., dollar values) extracted from the clause being outside a threshold range of typical values.

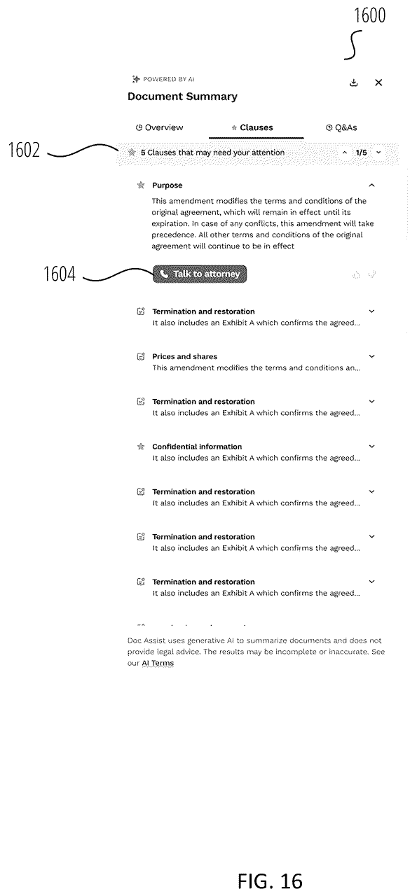

FIG. 16 is a user interface diagram showing a clauses section 1600, according to some examples. In some examples, the clauses section 1600 may be presented on the clauses page 1000 of FIG. 10. As illustrated in FIG. 16, the clauses section 1600 includes a listing of labels associated with specific clauses of an analyzed and summarized document. User selection of a label expands a summary description of a clause corresponding with the label. For example, in response to a selection of the label “Purpose,” a corresponding section of the clauses section 1600 is expanded to present a summary description of the purpose section of an analyzed and summarized document.

The clauses section 1600 includes a notification section 1602 that indicates a number of clauses (e.g., five) that are flagged as potentially being important and in need of further attention. When a label corresponding with a flagged clause is expanded, the summary description of the clause includes a selectable element 1604 to initiate a workflow for communicating with a qualified legal professional. As flagged clauses may be important clauses or clauses with unusual metrics, the inclusion of the selectable element 1604 here facilitates a natural response to such clauses, which includes communicating with a qualified legal professional.

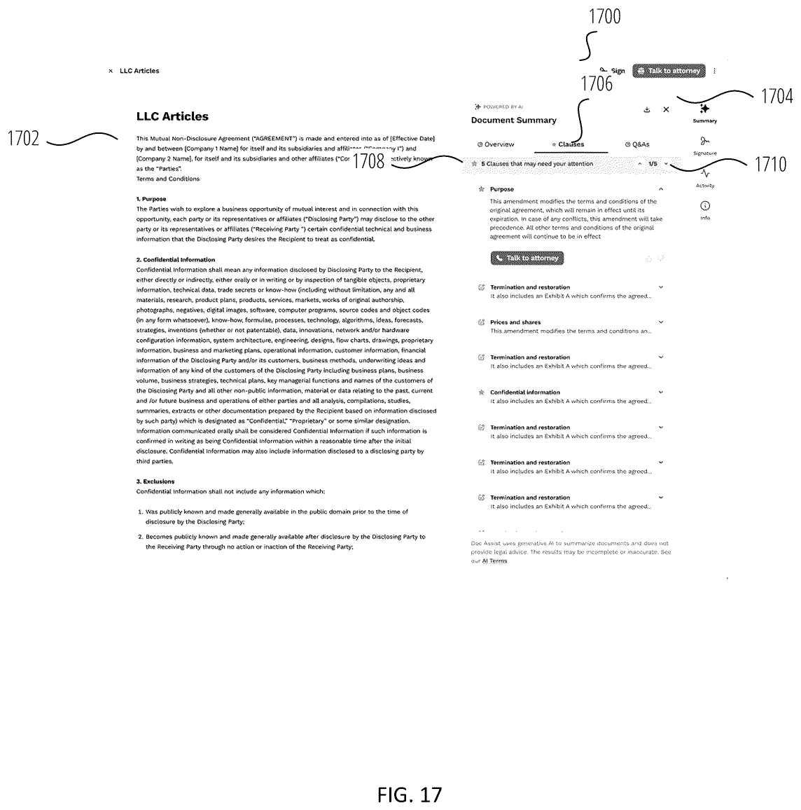

FIG. 17 is a user interface diagram showing a clauses page 1700, according to some examples. The clauses page 1700 is generated when the user selects the “Clauses” tab 1706 within the analysis section 1704 of the interface. The document section 1702 presents persistent text of an analyzed and summarized document, while the analysis section 1704 presents a clause analysis. Labels associated with specific clauses are displayed, and user selection of a label expands a summary description of the relevant clauses.

The analysis section 1704 includes a notification section 1708 that indicates a number of clauses (e.g., five) that are flagged as potentially being important and in need of further attention. The notification section 1708 includes navigation arrows 1710 that allow a user to navigate between the labels of the flagged clauses. In some examples, navigating to a label of a flagged clause via the navigation arrows 1710 causes the label to expand a summary description of the relevant clause and causes the document section 1702 to navigate to a portion of the document that is related to the label.

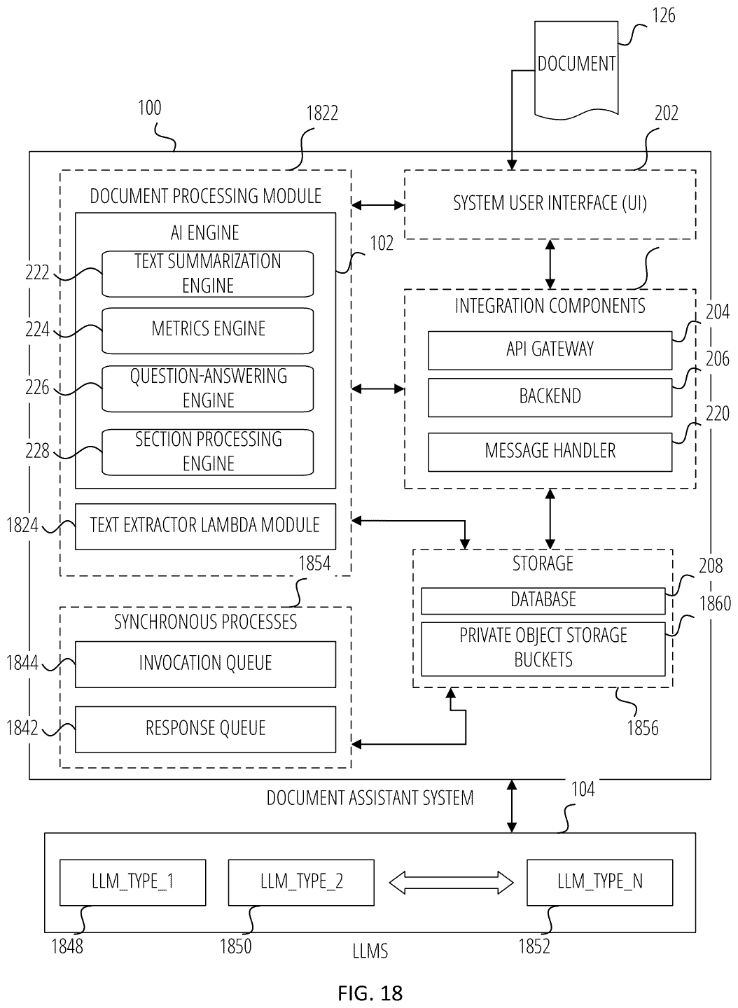

FIG. 18 is a block diagram illustrating an architecture of a document assistant system 100, according to some examples, that comprises multiple components that work together to enable automated analysis and summarization of legal documents.

At the core is a document processing module 1822 containing an AI engine 102 that runs various algorithms for summarization, metrics extraction, question answering, and clause identification. The AI engine 102 leverages large language models (LLMs 104, including LLM engine 318, LLM engine 320 and LLM engine 520) such as GPT-3.5 and GPT-4 to implement these advanced natural language processing techniques. The document processing module 1822 also comprises a text extractor lambda module 1824 that extracts plain text from input documents 126 to feed into the AI engine 102.

Summarization capabilities are provided via integration with a large language model API, which can generate concise overviews of documents based on the AI engine's preprocessed text.

For storage 1856, the document assistant system 100 utilizes both a database 208 and private object storage buckets 1820. The database 208 stores original documents, extracted text, and metadata to allow persistent access to data during and after processing. Different database technologies may be used include:
Relational databases like PostgreSQL, MySQL, Microsoft SQL Server, and Oracle Database for structured storage using schema-based tables.
NoSQL databases like MongoDB, Apache Cassandra, Redis, Apache HBase for unstructured or semi-structured data using more flexible data models.
Graph databases like Neo4j and Amazon Neptune for storing and querying relationships between entities.
Time-series databases like InfluxDB and TimescaleDB optimized for ordering data by timestamps.

In addition, private object storage buckets 1820 provide secure, isolated storage of documents and AI outputs for each user. Different object storage technologies that may be leveraged include:
Public cloud solutions like Amazon S3, Azure Blob Storage, and Google Cloud Storage buckets for scalable cloud storage.
Open-source options like MinIO for deploying private S3-compatible object storage on-premises.
Distributed file systems like HDFS that replicate data across clusters.
Block storage systems like Dell EMC ECS and IBM Spectrum Scale for large binary object storage.

The private object storage buckets 1820 allow storing unstructured document data separately from the relational metadata, while providing security at the individual user level. The exact technologies can be selected based on factors like scalability, cost, and deployment preferences.

The document assistant system 100 includes various integration components 1858. These include an API gateway 204 that handles requests from the system user interface (UI) 202 and routes them to a backend 206 that coordinates the core document processing logic. A message handler 220 coordinates sending documents 126 to the AI engine 102 and processing the responses asynchronously. Synchronous processes 1254 include invocation queues 1844 and response queues 1842 that enable asynchronous AI processing for improved throughput.

The system user interface (UI) 202 consists of various pages to upload documents, view extracted information, and download outputs. A landing page allows document uploads. An asset page displays the processing status of documents. A summary page shows document text and analysis like key facts, clauses, and Q&A extracted by the AI engine. Additional pages display clause and FAQ analysis.

Together these components provide an intelligent pipeline to ingest documents, apply AI algorithms, store data, integrate with language models, coordinate processing, and deliver results to users. The modular architecture supports scalability and upgrades.

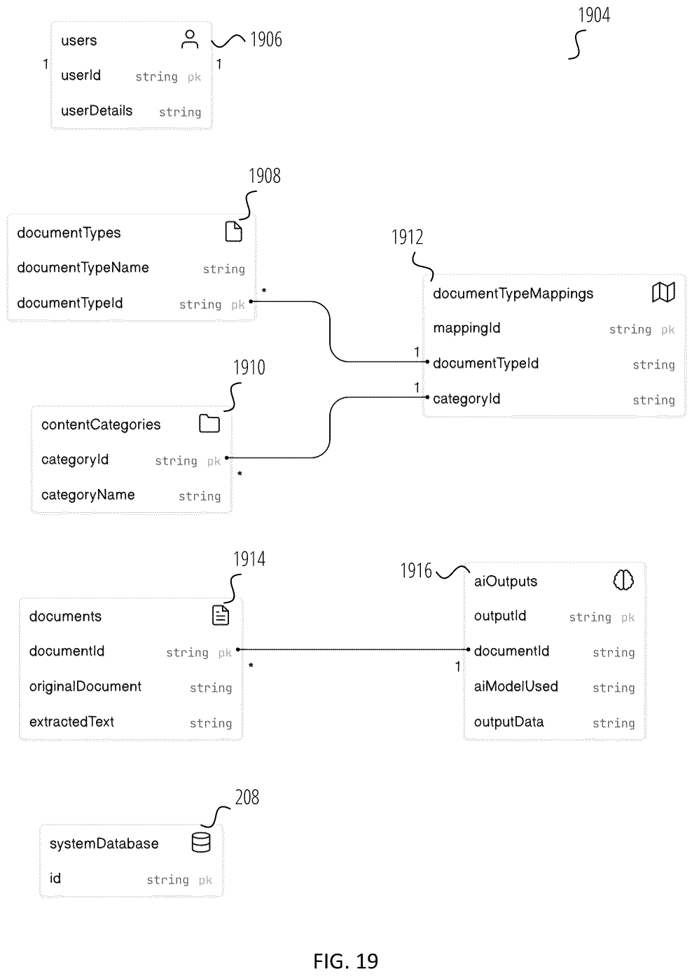

FIG. 19 is an entity-relationship diagram showing a relational data architecture 1904, according to some examples, employed within the database 208 to store and organize information needed for the document analysis workflow performed by the document assistant system 100. At the center is the database 208 which maintains all persistent data.

The system database 1918 stores details on users in a users table 1906. This includes unique user IDs along with associated user information like names, roles, contact details, and other relevant attributes.

A document type table 1908 catalogs the supported document/contract types that can be processed by the system. Each document type has a unique ID and name, like “NDA” or “Services Agreement”.

The content categories table 1910 lists various content categories that correspond to standard sections present in different document types. For example, “Parties”, “Term/Termination”, “Dispute Resolution”. Each category has a unique ID and name.

A further table is the document type mapping table 1912. This maps entries in the document type table 1908 to associated categories in the content categories table 1910. Each mapping has a unique ID, document type ID, and category ID, creating a many-to-many linkage between document types and expected content categories.

The documents table 1914 contains records for each document 126 uploaded to the document assistant system 100 for analysis. This includes a unique document ID, the original file content, and any extracted text.

Finally, the AI outputs table 1916 stores results from running various AI algorithms on the documents. Each output entry has an ID, the source document ID, details on the AI model used, and the actual output data like summaries or key facts extracted from the document.

By relating information across these structured tables, the database 208 supports the document processing workflow and provides standardization for categorizing and analyzing documents based on their type.

The document type table 1908, content categories table 1910, and the document type mapping table 1912 provide an example of a mapping data structure stored in the database 208 that maps contract/document types to associated content categories. For example, the mapping may specify that a Non-Disclosure Agreement (NDA) document type corresponds to content categories including:
Parties
Definition of Confidential Information
Obligations to Protect Information
Exclusions
Term/Termination
Dispute Resolution
etc.

Similarly, a Services Agreement document type may map to categories like:
Parties
Scope of Services
Service Levels/Performance
Payment Terms
Term/Termination
IP Ownership
Confidentiality
Warranties
Limitation of Liability
Dispute Resolution
etc.

In some examples, the mapping data structure may be implemented as database tables linking each predefined document type to its respective set of content categories expected to be present in that type of document, as described above. In some examples, a spreadsheet may provide the mapping data structure.

This provides a standardized schema to classify clauses and sections based on the identified document type. The content categories can be customized over time to adapt to new document templates and evolving contract standards.

At runtime, when a document type is identified by the AI engine 102, the associated content categories are looked up in the mapping data structure. This drives downstream processing to extract and summarize text corresponding to those categories using natural language algorithms. The relational mapping data may be helpful to tailoring the analysis specifically to each document type for more intelligent, context-aware summarization.

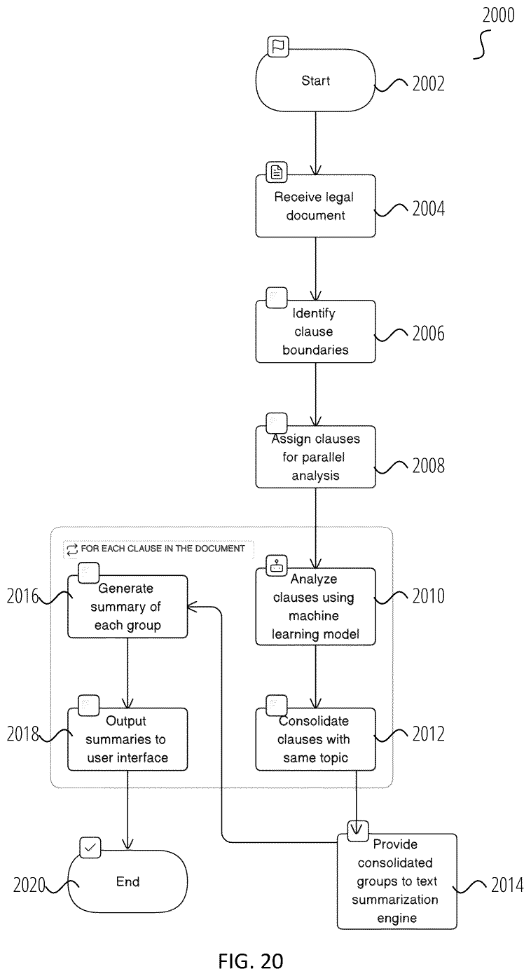

FIG. 20 is a flowchart of a method 2000 for summarizing clauses in a legal document, according to some examples. The operations illustrated in the method 2000 may be performed, for example, by the document assistant system 100 of FIG. 1. Although the method 2000 depicts a particular sequence of operations, the sequence may be altered without departing from the scope of the present disclosure. For example, some of the operations depicted may be performed in parallel or in a different sequence that does not materially affect the function of the method.

At operation 2002, the method 2000 starts operations for summarizing clauses in a legal document. The operations may be initiated, for example, in response to an uploaded legal document or a selection of a previously uploaded legal document.

At operation 2004, a legal document is received. A document assistant system may receive the legal document via various communication processes, such as an upload operation or a transfer operation from a database.

At operation 2006, clause boundaries are identified. The document assistant system employs natural language processing techniques to detect and delineate individual clauses within the document. The document assistant system analyzes the document's structure, formatting, and textual cues to accurately identify where each clause begins and ends.

At operation 2008, clauses are assigned for parallel analysis. The document assistant system assigns clauses that have been identified based on their clause boundaries for processing in parallel, such as through an SQS queue. Parallel processing allows multiple clauses to be analyzed simultaneously, reducing overall processing time.

At operation 2010, each clause is analyzed using a machine learning model. The model is trained to understand and interpret legal language, identify key information, extract metrics of each clause, and identify the overall purpose of each clause. In some examples, the machine learning model is trained to categorize the clauses and prepare the clauses for summarization.

At operation 2012, clauses with the same topic are consolidated. The document assistant system consolidates clauses that are related in terms of topic, subject matter, content, and legal implications. The consolidated groups of clauses may be labeled with the topic or the subject matter to which they pertain.

At operation 2014, consolidated groups are provided to a text summarization engine. The text summarization engine generates summaries for each consolidated group of clauses.

At operation 2016, a summary of each group is generated. The text summarization engine processes each clause of a group and generates a summary capturing key points and metrics from the group of clauses. The key points and metrics are summarized using natural language techniques to generate a digestible, plain language summary of the group of clauses.

At operation 2018, the summary of each group is output to a user interface. For example, the summary of each group may be presented through a clause page alongside the received document.

At operation 2020, the method 2000 ends. The summaries generated for the document may be saved for the user and accessed again at a later time.

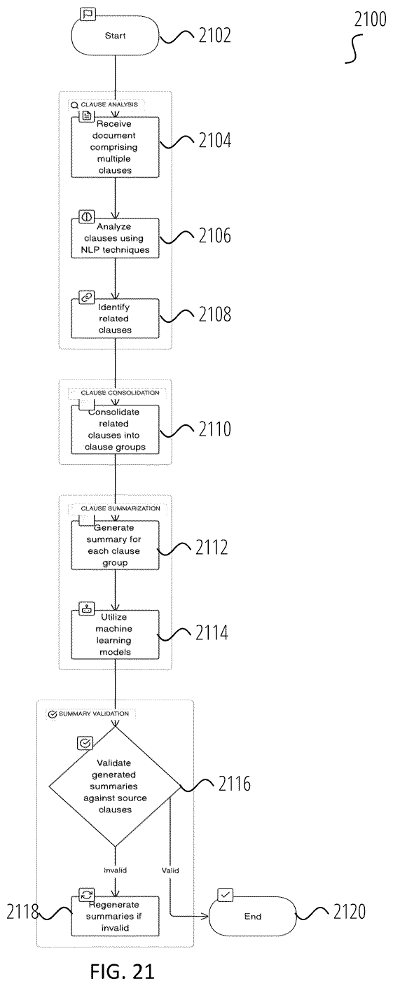

FIG. 21 is a flowchart of a method 2100 for summarizing clauses in a legal document, according to some examples. The operations illustrated in the method 2100 may be performed, for example, by the document assistant system 100 of FIG. 1. Although the method 2100 depicts a particular sequence of operations, the sequence may be altered without departing from the scope of the present disclosure. For example, some of the operations depicted may be performed in parallel or in a different sequence that does not materially affect the function of the method.

At operation 2102, the method 2100 starts operations for summarizing clauses in a legal document. The operations may be initiated, for example, in response to an uploaded legal document or a selection of a previously uploaded legal document.

At operation 2104, a legal document comprising multiple clauses is received. A document assistant system may receive the legal document via various communication processes, such as an upload operation or a transfer operation from a database.

At operation 2106, the clauses are analyzed using natural language processing (NLP) techniques. The document assistant system employs NLP techniques to analyze the content and structure of each clause. This operation may involve tokenization, parsing, and semantic analysis to understand the meaning and context of the clauses.

At operation 2108, related clauses are identified. The document assistant system identifies clauses that are related in terms of topic, subject matter, content, and legal implications. The identification may be performed using a machine learning model based on NLP techniques. As illustrated in FIG. 21, operations 2104-2108 are part of a clause analysis phase of the method 2100.

At operation 2110, related clauses are consolidated into clause groups as part of a clause consolidation phase of the method 2100. The document assistant system consolidates related clauses into groups based on the topics, subject matter, content, and legal implications of the clauses. This allows clauses that are related but not contiguous in the legal document to be grouped together for analysis and summary.

At operation 2112, a summary for each clause is generated. The document assistant system generates a summary for each consolidated group of related clauses. The document assistant system employs text summarization techniques to identify key information and key metrics to include in the summary.

At operation 2114, machine learning models are utilized to generate the summary. The document assistant system trains and employs machine learning models to analyze and summarize legal documents. Machine learning models may be trained to recognize patterns in legal language, legal document structures, and clause types through a training process in which training instances of legal documents and ground truth annotations from legal professionals are provided to the machine learning models. In the training process, the machine learning models are iteratively adjusted with respect to the weights and parameters of the machine learning models to minimize a loss function (e.g., cross-entropy, mean squared error) between the outputs of the machine learning models and the ground truth annotations. The trained machine learning models are applied to the legal documents received by the document assistant system to analyze and summarize the legal documents.

In some examples, machine learning models are trained using manually annotated clauses to enhance classification accuracy. The training data comprises a curated set of legal documents where qualified legal professionals have annotated and classified clauses according to predefined section categories. During training, the machine learning models learn to identify patterns and relationships between clause content and their corresponding classifications. This training approach enables the machine learning models to accurately categorize clauses in new documents by comparing them against the learned patterns from the manually annotated training set.

As illustrated in FIG. 21, operations 2112-2114 are part of a clause summarization phase of the method 2100.

At operation 2116, the generated summaries are validated against source clauses. The document assistant system checks the accuracy and completeness of the generated summaries by comparing them to the source clauses. Validated summaries include the same key information and key metrics identified in the source clauses. Invalidated summaries include key information and key metrics different from the key information and key metrics identified in the source clauses.

If the generated summaries are invalid, then at operation 2118, summaries are regenerated. The summaries are regenerated, for example, by returning to the clause summarization phase of the method 2100. Parameters used by the machine learning models may be adjusted to produce different, more accurate results. In some examples, the summaries are regenerated by returning to the clause analysis phase of the method 2100.

If the generated summaries are valid, then at operation 2120, the method 2100 ends. The validated summaries may be provided, for example, through a clauses page.

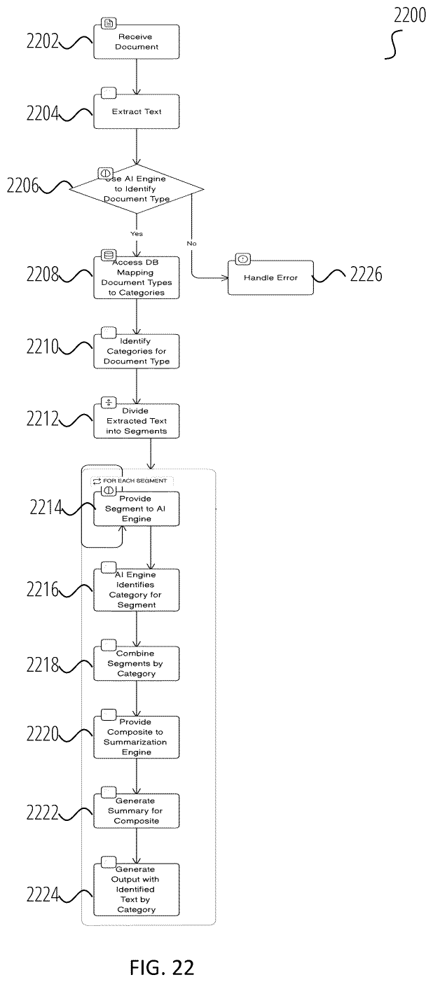

FIG. 22 is a flowchart of a method 2200 for processing a legal document for analysis and summarization. The operations illustrated in the method 2200 may be performed, for example, by the document assistant system 100 of FIG. 1. Although the method 2200 depicts a particular sequence of operations, the sequence may be altered without departing from the scope of the present disclosure. For example, some of the operations depicted may be performed in parallel or in a different sequence that does not materially affect the function of the method.

At operation 2202, a legal document is received. A document assistant system receives a legal document for analysis. The legal document may be received, for example, through an upload function or through a transfer from a database of uploaded documents.

At operation 2204, text is extracted from the legal document. The document assistant system extracts text from the legal document via, for example, optical character recognition (OCR) or text recognition techniques.

At operation 2206, an AI engine is used to identify a document type. The document assistant system leverages an AI engine and natural language processing techniques offered by the AI engine to analyze the extracted text to identify a document type. The document type may be associated with clause mappings and information categories for subsequent analysis and summarization of the legal document.

If the document assistant system is unable to identify the document type (e.g., not a legal document), then at operation 2206, the document assistant system performs an error handling process. For example, a notification may be generated to indicate that the document received by the document assistant system is not a legal document.

If the document assistant system is able to identify the document type, then at operation 2208, the document assistant system accesses a database of mappings between document types and content categories. The mappings identify key information and key metrics for document types. The mappings identify categories of the document types to which to categorize the extracted text, the key information, and the key metrics.

At operation 2210, categories are identified for a document type. The document assistant system identifies the categories related to the document type of the legal document. Segments of the extracted text can be consolidated based on the identified categories.

At operation 2212, the extracted text is divided into segments. The document assistant system divides the extracted text into segments based on an analysis of the contents and structure of the extracted text.

At operation 2214, each segment is provided to an AI engine. The document assistant system provides each segment to an AI engine to identify the category to which each segment belongs. The AI engine extracts key information and key metrics from each segment. Additionally, the AI engine extracts the content of each segment for categorizing the segment.

At operation 2216, a category is identified for each segment by the AI engine. The document assistant system identifies the category to which each segment belongs using the AI engine. The categories are identified based on the context extracted from each segment.

At operation 2218, the segments are combined (e.g., concatenated) by category. The document assistant system combines segments belonging to the same category and consolidates the segments into groups. Thus, segments that may not be contiguous in the legal document are combined together into one group relating to the same category.

At operation 2220, a composite is provided to a summarization engine. The document assistant system provides a composite of the combined segments to a summarization engine to generate a summary for the composite. The summary includes the key information and key metrics extracted from the segments of the composite and provides the content of the segments in a digestible, non-legal summary.

At operation 2222, a summary is generated for the composite. The document assistant system generates the summary using the summarization engine. The summary is associated with the composite of the combined segments.

At operation 2224, an output is generated with identified text by category. The document assistant system generates an output that includes the identified text from the legal document organized by category. The output may, for example, be a clauses page of a user interface with which a user may interact to navigate through the legal document.

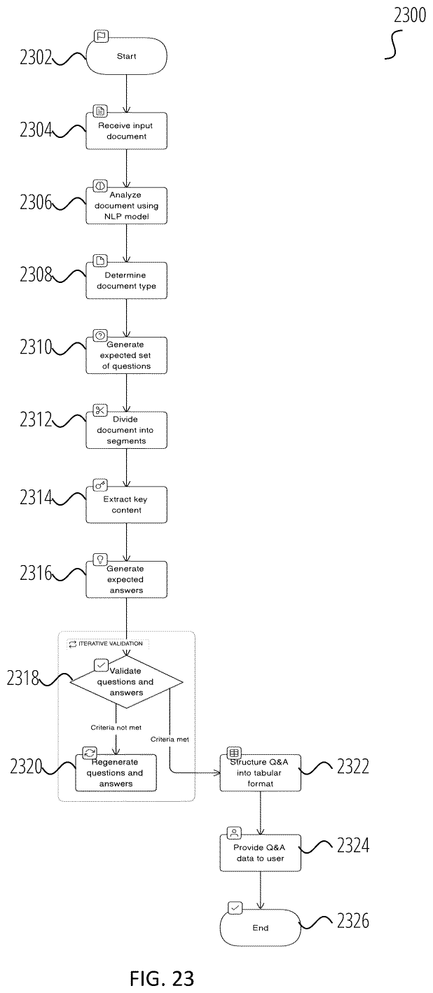

FIG. 23 is a flowchart of a method 2300 for generating question-and-answer data for a legal document, according to some examples. The operations illustrated in the method 2300 may be performed, for example, by the document assistant system 100 of FIG. 1. Although the method 2300 depicts a particular sequence of operations, the sequence may be altered without departing from the scope of the present disclosure. For example, some of the operations depicted may be performed in parallel or in a different sequence that does not materially affect the function of the method.

At operation 2302, the method 2300 starts operations for generating question-and-answer data for a legal document. The operations may be initiated, for example, in response to an uploaded legal document or a selection of a previously uploaded legal document.

At operation 2304, an input document is received. A document assistant system may receive a legal document as an input document for analysis. The legal document may be received, for example, via an upload operation or a transfer operation.

At operation 2306, the document is analyzed using a natural language processing (NLP) model. The document assistant system analyzes the contents of the document using an NLP model. The NLP model may perform a semantic analysis of the contents of the document to understand the context of the document.

At operation 2308, a document type is determined. The document assistant system determines a document type based on the semantic analysis by the NLP model. The document type of the document may be indicative of questions that a user may ask regarding the document.

At operation 2310, an expected set of questions is generated. The document assistant system generates an expected set of questions related to the document based on the analysis by the NLP model. The NLP model may be trained to generate question patterns based on document type and content. The question patterns allow for the key information and the key metrics of the document to be presented in a digestible, non-legal format.

At operation 2312, the document is divided into segments. The document assistant system divides the document into segments that are processed in parallel. The segments are divided based on the structure and content of the document.

At operation 2314, key content is extracted. The document assistant system extracts key information and key metrics from the segments. The key information and the key metrics may be responsive to the question pattern generated for the document.

At operation 2316, expected answers are generated. The document assistant system generates expected answers to the set of expected questions based on the key information and the key metrics extracted from the segments. The expected answers provide the key information and the key metrics in the context of the set of questions and formulated to be responsive to the set of questions. For example, a conversational retrieval chain technique may be employed to formulate the key information and the key metrics into responsive answers.

At operation 2318, the questions and answers are validated. The document assistant system checks the generated questions and answers for accuracy, relevance, and completeness. The validation of the generated questions and answers may be performed by comparing the answers to the contents of the document to ensure that the key information and the key metrics used in the answers match the key information and the key metrics of the document.

If the questions and answers are not validated, then at operation 2320, the questions and answers are regenerated. The regeneration of the questions and the answers may involve adjusting parameters of the NLP model to produce different, more accurate, and more relevant questions and answers. As illustrated in FIG. 23, operations 2318-2320 are part of an iterative validation phase of the method 2300 to iteratively improve the questions and answers generated by the document assistant system until they are validated.

If the questions and answers are validated, then at operation 2322, the questions and answers are structured into a tabular format. The tabular format allows for the questions and answers to be presented in a readable and accessible format when provided to a user.

At operation 2324, the questions and answers are provided to a user. The document assistant system provides the questions and answers to the user, for example, via a FAQ page. In some examples, the questions and answers are provided as part of a downloadable report.

At operation 2326, the method 2300 ends. The generated questions and answers for the document may be saved for the user and accessed again at a later time.

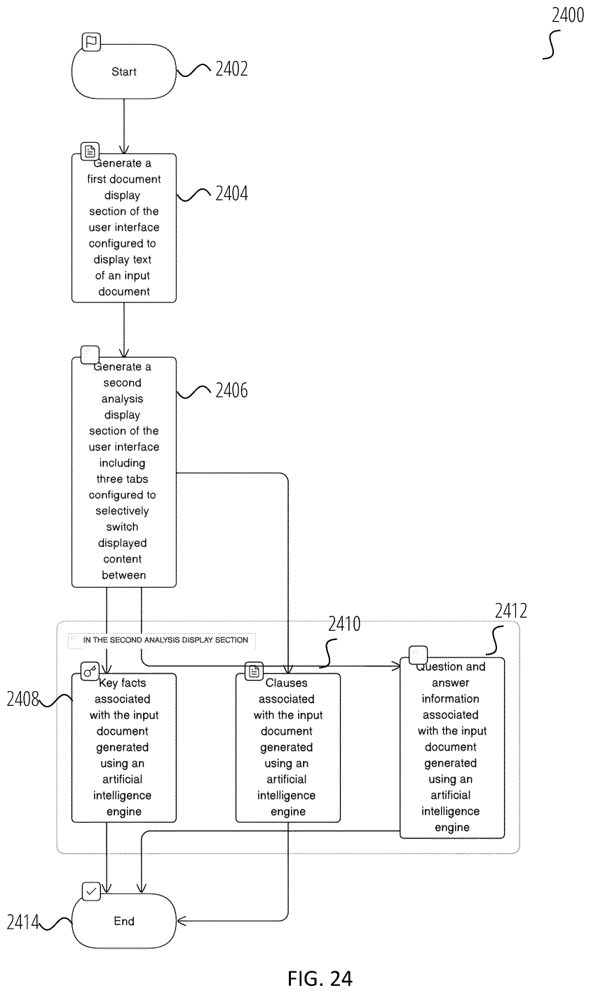

FIG. 24 is a flowchart of a method 2400 for generating a user interface for document analysis and summarization, according to some examples. The operations illustrated in the method 2400 may be performed, for example, by the document assistant system 100 of FIG. 1. Although the method 2400 depicts a particular sequence of operations, the sequence may be altered without departing from the scope of the present disclosure. For example, some of the operations depicted may be performed in parallel or in a different sequence that does not materially affect the function of the method.

At operation 2402, the method 2400 starts operations for generating a user interface for document analysis and summarization. The operations may be initiated, for example, in response to a user accessing a landing page or a navigation page of a document assistant system.

At operation 2404, the document assistant system generates a first document display section of the user interface configured to display text of an input document. The document assistant system creates a section of the user interface dedicated to displaying the original text of the input document. This allows users to view and reference the original content while reviewing the analysis and summaries.

At operation 2406, the document assistant system generates a second analysis display section of the user interface including three tabs configured to selectively switch displayed content between. The document assistant system creates another section of the user interface that contains three interactive tabs. These tabs allow users to switch between different types of analysis and summaries (e.g., overview, clauses, FAQ) generated by the document assistant system.

At operation 2408, the document assistant system generates, in the second analysis display section, key facts associated with the input document generated using an artificial intelligence (AI) engine. The key facts may be presented, for example, in an overview page of the user interface. The key facts are identified and summarized by the AI engine and presented in a digestible, non-legal format. In some examples, the key facts are presented in response to a selection of an overview tab of the second analysis display section.

At operation 2410, the document assistant system generates, in the second analysis display section, clauses associated with the input document generated using an artificial intelligence (AI) engine. The clauses are identified and summarized by the AI engine and presented to the user to highlight important clauses within the document. The clauses may be presented, for example, in a clauses page of the user interface and presented in response to a selection of a clauses tab of the second analysis display section.

At operation 2412, the document assistant system generates, in the second analysis display section, question and answer information associated with the input document generated using an artificial intelligence (AI) engine. The question-and-answer information are generated by the AI engine based on the contents of the input document. The question-and-answer information may be presented, for example, in a FAQ page of the user interface and presented in response to a selection of a FAQ tab of the second analysis display section.

At operation 2414, the method 2400 ends. The user may continue navigating the user interface or access the user interface at a later time. Information generated for the user (e.g., key facts, clauses, question and answer information) may be saved and accessed at a later time.

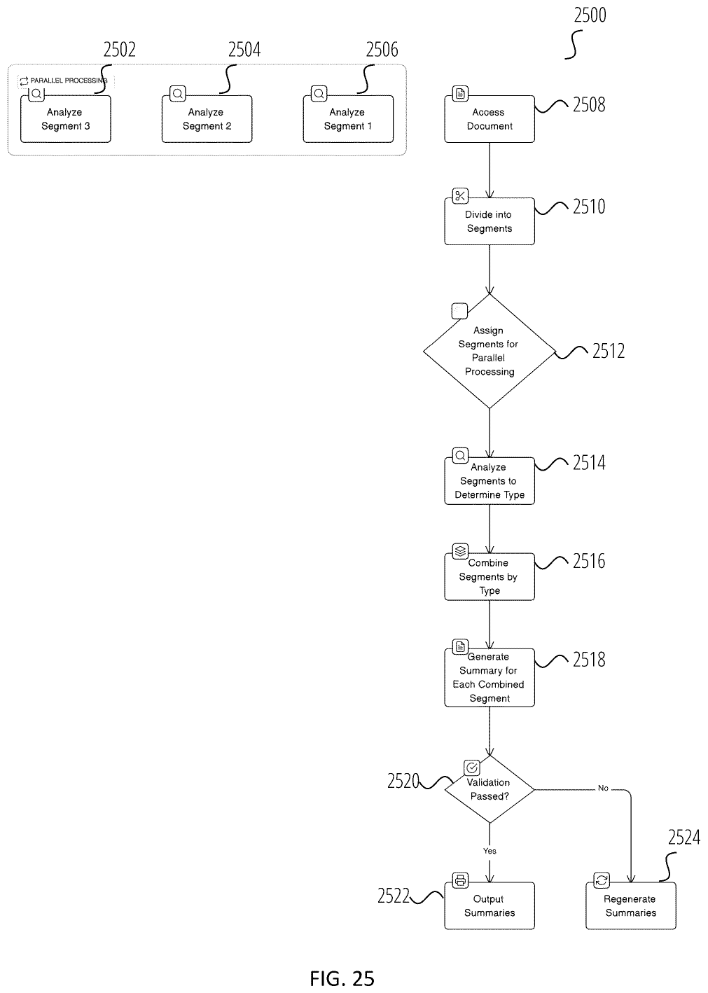

FIG. 25 is a flowchart of a method 2500 for parallel processing of document segments for analysis and summarization, according to some examples. The operations illustrated in the method 2500 may be performed, for example, by the document assistant system 100 of FIG. 1. Although the method 2500 depicts a particular sequence of operations, the sequence may be altered without departing from the scope of the present disclosure. For example, some of the operations depicted may be performed in parallel or in a different sequence that does not materially affect the function of the method. Furthermore, although the method 2500 depicts parallel processing of three segments, more or fewer segments may be processed in parallel without departing from the scope of the present disclosure.

At operation 2508, a document is accessed. A document assistant system may access the document via an upload operation through a user interface or via a retrieval operation from a database.

At operation 2510, the document is divided into segments. The document assistant system divides the document into segments for parallel processing. The division may be based on NLP techniques to identify semantic and structural boundaries by which to divide the document.

At operation 2512, the segments are assigned for parallel processing. The segments may be assigned based on available processing resources and sizes of the segments. The segments may be assigned to distribute computational load across multiple processing services to ensure efficient utilization of resources.

At operation 2514, the segments are analyzed to determine type. As illustrated in FIG. 25, the method 2500 involves parallel processing of three segments. At operation 2506, segment one is analyzed. At operation 2504, segment two is analyzed. At operation 2502, segment three is analyzed. Operations 2502-2506 may be performed in parallel using multiple processing resources. The segments are analyzed to determine document type. The analysis may be based on machine learning models, such as NLP classifiers, that are trained to categorize the contents of each segment into document types.

At operation 2516, the segments are combined by type. The document assistant system combines segments identified as belonging to the same document type to create a cohesive group of segments of the same document type.

At operation 2518, a summary is generated for each combined segment. The document assistant system uses machine learning models to generate summaries that include key facts and key metrics extracted from each group of segments. Each summary generated for each group of segments includes the key facts and the key metrics extracted from the group of segments.

At operation 2520, the summaries are validated. The document assistant system checks the generated summaries to ensure that the key facts and the key metrics included in the summaries match the key facts and the key metrics extracted from the corresponding group of segments.

If the summaries are not validated, then at operation 2524, the summaries are regenerated. The parameters of the machine learning models trained to generate the summaries may be adjusted to cause the machine learning models to generate different, more accurate, and more relevant summaries.

If the summaries are validated, then at operation 2522, the summaries are outputted. The summaries may be outputted, for example, through an overview page.

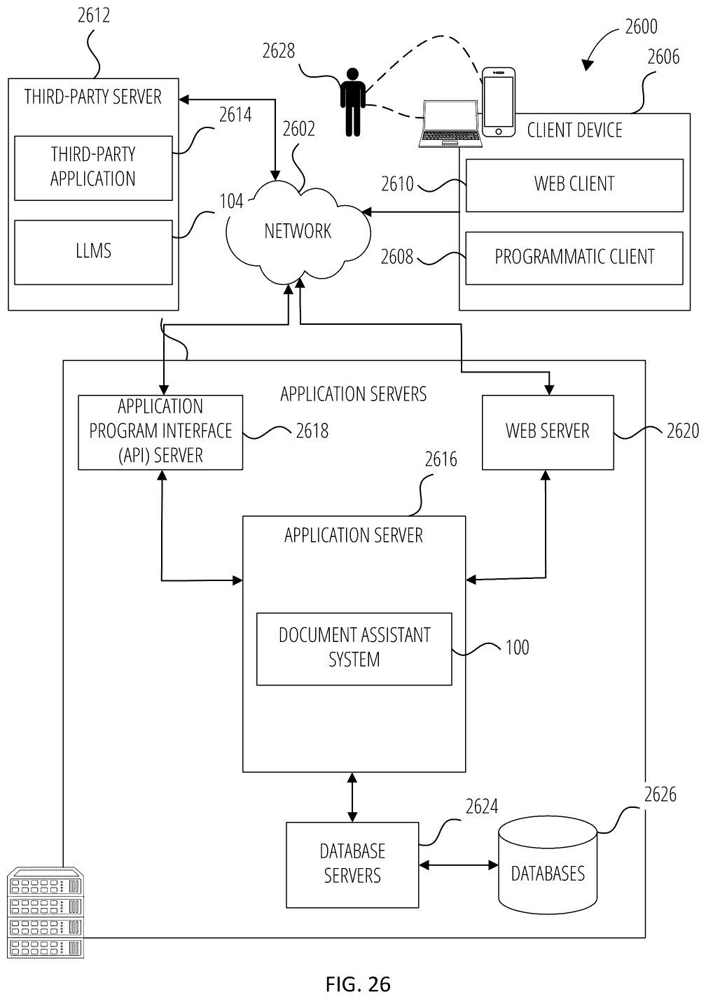

FIG. 26 is a diagrammatic representation of a networked computing environment 2600 in which some examples of the present disclosure may be implemented or deployed.

One or more application servers 2604 provide server-side functionality via a network 2602 to a networked user device, in the form of a client device 2606 that is accessed by a user 2628. A web client 2610 (e.g., a browser) and a programmatic client 2608 (e.g., an “app”) are hosted and executed on the web client 2610.

An Application Program Interface (API) server 2618 and a web server 2620 provide respective programmatic and web interfaces to application servers 2604. A specific application server 2616 hosts the document assistant systems 100, which includes components, modules and/or applications.

The web client 2610 communicates with the document assistant systems 100 via the web interface supported by the web server 2620. Similarly, the programmatic client 2608 communicates with the document assistant systems 100 via the programmatic interface provided by the Application Program Interface (API) server 2618.

The application server 2616 is communicatively coupled to database servers 2624, facilitating access to an information storage repository or databases 2626. In some examples, the database databases 2626 include storage devices that store information to be published and/or processed by the document assistant systems 100.

Additionally, a third-party application 2614 executing on a third-party server 2612, has programmatic access to the application server 2616 via the programmatic interface provided by the Application Program Interface (API) server 2618. For example, the third-party application 2614, using information retrieved from the application server 2616, may support one or more features or functions on a website hosted by a third party.

Third-party servers 2612 may also host LLMs 104 discussed herein which are accessible to the document assistant system 100 via the Application Program Interface (API) server 2618 or web server 2620.

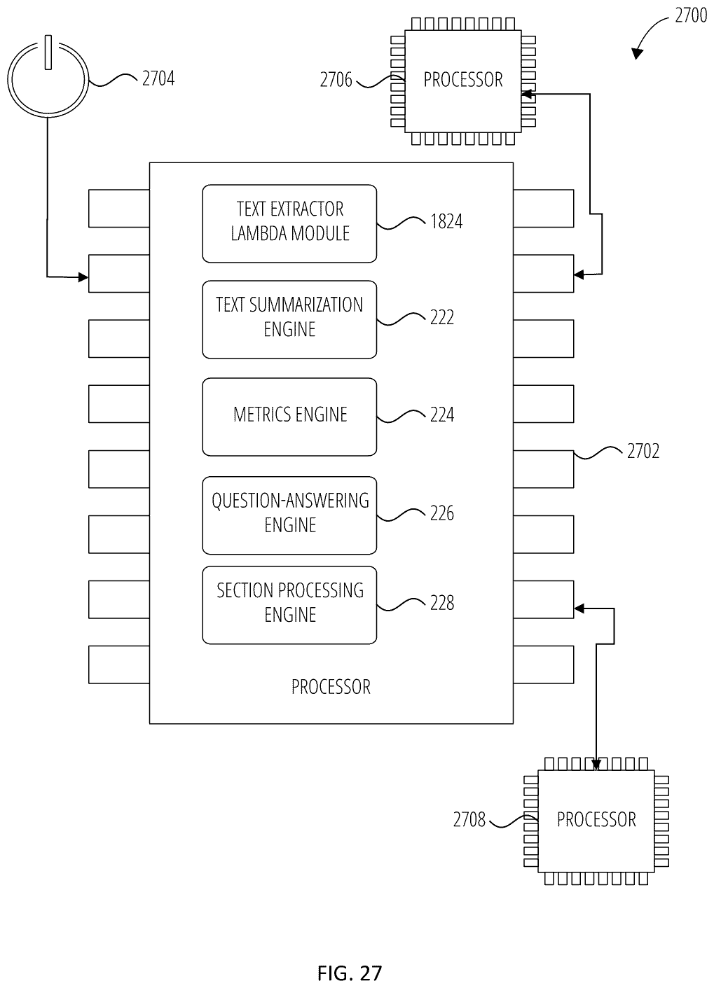

Turning now to FIG. 27, a diagrammatic representation of a processing environment 2700 is shown, which includes multiple processors, including processor 2702, processor 2706 and processor 2706 (e.g., a GPU, CPU, or combination thereof).

The processor 2702 is shown to be coupled to a power source 2704, and to include (either permanently configured or temporarily instantiated) components, namely text extractor lambda module 1824, text summarization engine 222, metrics engine 224, question-answering engine 226, and section processing engine 228.

As illustrated, the processor 2702 is communicatively coupled to both the processor 2706 and the processor 2708, and receives extracted text from the processor 2706, as well as identified contract types from the processor 2708.

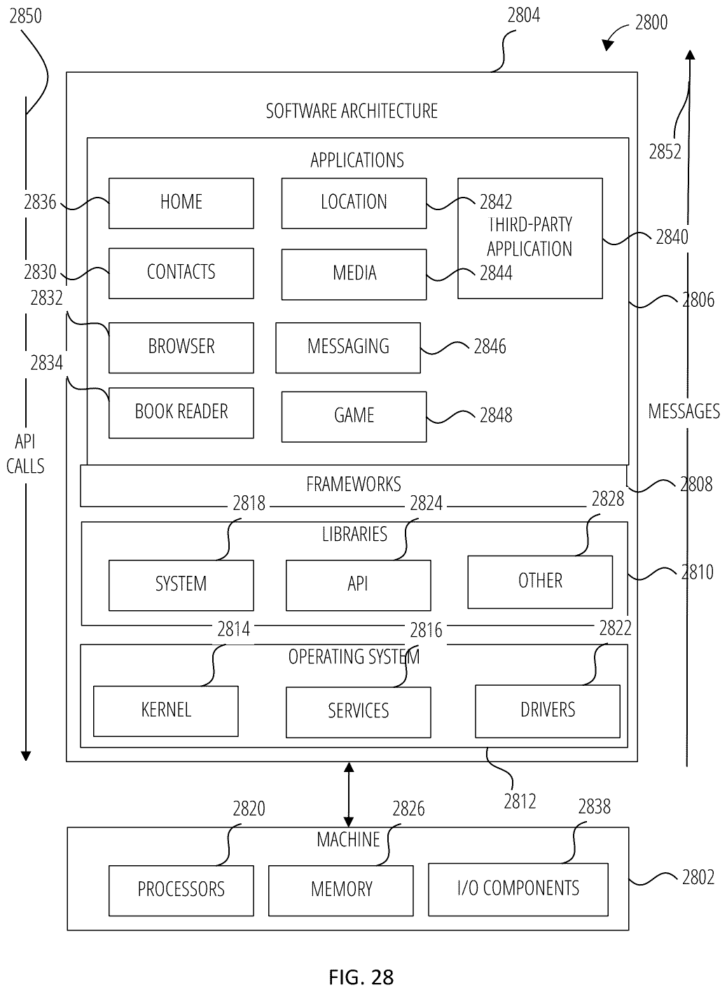

FIG. 28 is a block diagram 2800 illustrating a software architecture 2804, which can be installed on any one or more of the devices described herein. The software architecture 2804 is supported by hardware such as a machine 2802 that includes processors 2820, memory 2826, and I/O components 2838. In this example, the software architecture 2804 can be conceptualized as a stack of layers, where each layer provides a particular functionality. The software architecture 2804 includes layers such as an operating system 2812, libraries 2810, frameworks 2808, and applications 2806. Operationally, the applications 2806 invoke API calls 2850 through the software stack and receive messages 2852 in response to the API calls 2850.

The operating system 2812 manages hardware resources and provides common services. The operating system 2812 includes, for example, a kernel 2814, services 2816, and drivers 2822. The kernel 2814 acts as an abstraction layer between the hardware and the other software layers. For example, the kernel 2814 provides memory management, Processor management (e.g., scheduling), component management, networking, and security settings, among other functionalities. The services 2816 can provide other common services for the other software layers. The drivers 2822 are responsible for controlling or interfacing with the underlying hardware. For instance, the drivers 2822 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, and power management drivers.

The libraries 2810 provide a low-level common infrastructure used by the applications 2806. The libraries 2810 can include system libraries 2818 (e.g., C standard library) that provide functions such as memory allocation functions, string manipulation functions, mathematic functions, and the like. In addition, the libraries 2810 can include API libraries 2824 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., Web Kit to provide web browsing functionality), and the like. The libraries 2810 can also include a wide variety of other libraries 2828 to provide many other APIs to the applications 2806.

The frameworks 2808 provide a high-level common infrastructure used by the applications 2806. For example, the frameworks 2808 provide various graphical user interface (GUI) functions, high-level resource management, and high-level location services. The frameworks 2808 can provide a broad spectrum of other APIs that can be used by the applications 2806, some of which may be specific to a particular operating system or platform.

In some examples, the applications 2806 may include a home application 2836, a contacts application 2830, a browser application 2832, a book reader application 2834, a location application 2842, a media application 2844, a messaging application 2846, a game application 2848, and a broad assortment of other applications such as a third-party application 2840. The applications 2806 are programs that execute functions defined in the programs. Various programming languages can be employed to create one or more of the applications 2806, structured in a variety of manners, such as object-oriented programming languages (e.g., Objective-C, Java, or C++) or procedural programming languages (e.g., C or assembly language).In a specific example, the third-party application 2840 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 2840 can invoke the API calls 2850 provided by the operating system 2812 to facilitate functionality described herein.

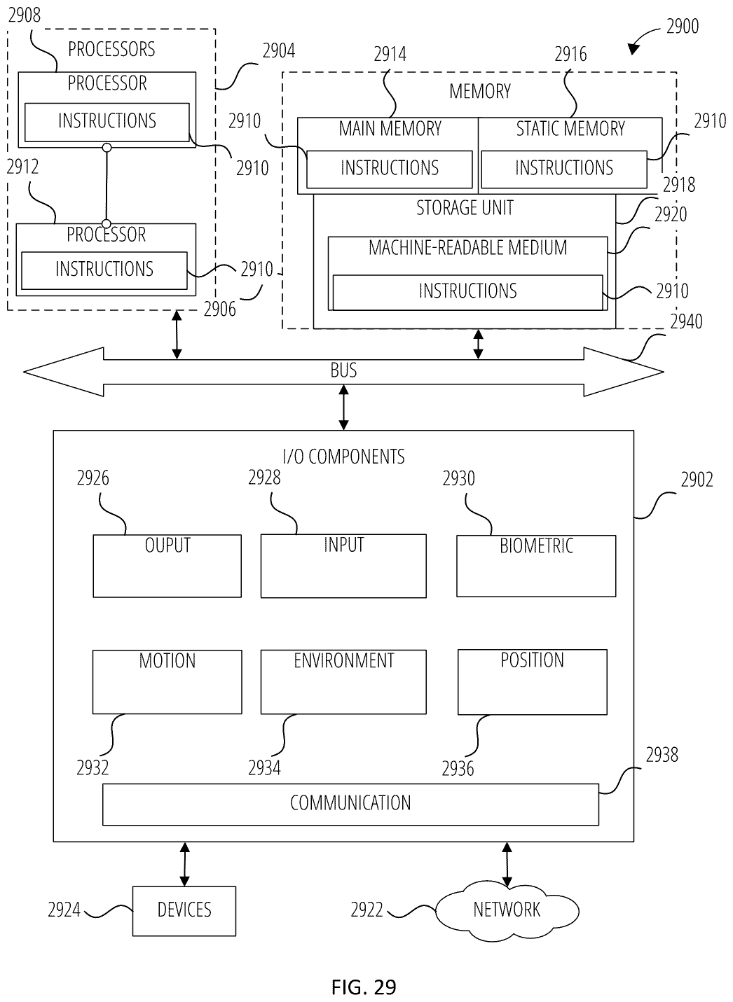

FIG. 29 is a diagrammatic representation of the machine 2900 within which instructions 2910 (e.g., software, a program, an application, an applet, an app, or other executable code) for causing the machine 2900 to perform any one or more of the methodologies discussed herein may be executed. For example, the instructions 2910 may cause the machine 2900 to execute any one or more of the methods described herein. The instructions 2910 transform the general, non-programmed machine into a particular machine 2900 programmed to carry out the described and illustrated functions in the manner described. The machine 2900 may operate as a standalone device or be coupled (e.g., networked) to other machines. In a networked deployment, the machine 2900 may operate in the capacity of a server machine or a client machine in a server-client network environment, or as a peer machine in a peer-to-peer (or distributed) network environment. The machine 2900 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 2910, sequentially or otherwise, that specify actions to be taken by the machine 2900. Further, while a single machine 2900 is illustrated, the term “machine” may include a collection of machines that individually or jointly execute the instructions 2910 to perform any one or more of the methodologies discussed herein.

The machine 2900 may include processors 2904, memory 2906, and I/O components 2902, which may be configured to communicate via a bus 2940. In some examples, the processors 2904 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 2908 and a processor 2912 that execute the instructions 2910. Although FIG. 29 shows multiple processors 2904, the machine 2900 may include a single processor with a single core, a single processor with multiple cores (e.g., a multi-core processor), multiple processors with a single core, multiple processors with multiples cores, or any combination thereof.

The memory 2906 includes a main memory 2914, a static memory 2916, and a storage unit 2918, both accessible to the processors 2904 via the bus 2940. The main memory 2906, the static memory 2916, and storage unit 2918 store the instructions 2910 embodying any one or more of the methodologies or functions described herein. The instructions 2910 may also reside, wholly or partially, within the main memory 2914, within the static memory 2916, within machine-readable medium 2920 within the storage unit 2918, within the processors 2904 (e.g., within the processor's cache memory), or any suitable combination thereof, during execution thereof by the machine 2900.

The I/O components 2902 may include various components to receive input, provide output, produce output, transmit information, exchange information, or capture measurements. The specific I/O components 2902 included in a particular machine depend on the type of machine. For example, portable machines such as mobile phones may include a touch input device or other such input mechanisms, while a headless server machine will likely not include such a touch input device. The I/O components 2902 may include many other components not shown in FIG. 29. In various examples, the I/O components 2902 may include output components 2926 and input components 2928. The output components 2926 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 2928 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 2902 may include biometric components 2930, motion components 2932, environmental components 2934, or position components 2936, among a wide array of other components. For example, the biometric components 2930 include components to detect expressions (e.g., hand expressions, facial expressions, vocal expressions, body gestures, or eye-tracking), measure bio signals (e.g., blood pressure, heart rate, body temperature, perspiration, or brain waves), or identify a person (e.g., voice identification, retinal identification, facial identification, fingerprint identification, or electroencephalogram-based identification). The motion components 2932 include acceleration sensor components (e.g., accelerometer), gravitation sensor components, rotation sensor components (e.g., gyroscope). The environmental components 2934 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2936 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2902 further include communication components 2938 operable to couple the machine 2900 to a network 2922 or devices 2924 via respective coupling or connections. For example, the communication components 2938 may include a network interface Component or another suitable device to interface with the network 2922. In further examples, the communication components 2938 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2924 may be another machine or any of a wide variety of peripheral devices (e.g., a peripheral device coupled via a USB).

Moreover, the communication components 2938 may detect identifiers or include components operable to detect identifiers. For example, the communication components 2938 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 2938, such as location via Internet Protocol (IP) geolocation, location via Wi-Fi® signal triangulation, or location via detecting an NFC beacon signal that may indicate a particular location.

The various memories (e.g., main memory 2914, static memory 2916, and/or memory of the processors 2904) and/or storage unit 2918 may store one or more sets of instructions and data structures (e.g., software) embodying or used by any one or more of the methodologies or functions described herein. These instructions (e.g., the instructions 2910), when executed by processors 2904, cause various operations to implement the disclosed examples.

The instructions 2910 may be transmitted or received over the network 2922, using a transmission medium, via a network interface device (e.g., a network interface component included in the communication components 2938) and using any one of several well-known transfer protocols (e.g., hypertext transfer protocol (HTTP)). Similarly, the instructions 2910 may be transmitted or received using a transmission medium via a coupling (e.g., a peer-to-peer coupling) to the devices 2924.

### GLOSSARY

“Network” may refer to one or more portions of a network that are coupled together to form an end-to-end communication path between two points. The communication network may be comprised of multiple network portions using different permutations and combinations of network types.

Example network portions may include:
An ad hoc network
An intranet
An extranet
A virtual private network (VPN)
A local area network (LAN)
A wireless LAN (WLAN)
A wide area network (WAN)
A wireless WAN (WWAN)
A metropolitan area network (MAN)
The Internet
A portion of the Internet.
A portion of the Public Switched Telephone Network (PSTN)
A plain old telephone service (POTS) network
A cellular telephone network
A wireless network
A Wi-Fi® network
Another type of network
A combination of two or more such networks

Specific examples may include:
5G networks
Low power wide area networks (LPWANs) like LoRaWAN or Sigfox
Narrowband internet of things (NB-IoT)
6G networks
Bluetooth
Zigbee
Thread
Z-Wave
Near Field Communication (NFC)
Radio Frequency Identification (RFID)
Message Queuing Telemetry Transport (MQTT)
Constrained Application Protocol (CoAP)
Controller Area Network (CAN) bus
FlexRay
Bluetooth
Zigbee
Thread
Body area networks (BANs)
Wireless USB

Example communication networks may utilize a variety of data transfer technologies, such as:
Single Carrier Radio Transmission Technology (1×RTT)
Evolution-Data Optimized (EVDO) technology
General Packet Radio Service (GPRS) technology
Enhanced Data rates for GSM Evolution (EDGE) technology
Third Generation Partnership Project (3GPP) including 3G
Fourth-generation wireless (4G) networks
Universal Mobile Telecommunications System (UMTS)
High-Speed Packet Access (HSPA)
Worldwide Interoperability for Microwave Access (WiMAX)
Long Term Evolution (LTE) standard
Others defined by various standard-setting organizations
Other long-range protocols
Other data transfer technology.

“Component” may refer to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner In some examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. A decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of methods described herein may be performed by one or more processors or processor-implemented components. Moreover, the one or more processors may also operate to support performance of the relevant operations in a “cloud computing” environment or as a “software as a service” (SaaS).For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In some examples, the processors or processor-implemented components may be distributed across a number of geographic locations.

“Module” may refer to logic having boundaries defined by function or subroutine calls, branch points, Application Program Interfaces (APIs), or other technologies that provide for the partitioning or modularization of particular processing or control functions. Modules are typically combined via their interfaces with other modules to carry out a machine process. A module may be a packaged functional hardware unit designed for use with other components and a part of a program that usually performs a particular function of related functions. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” (or “hardware-implemented module”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information). The various operations of example methods and routines described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors. Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

“Non-transitory computer-readable medium” refers, for example, to one or more storage devices and media (e.g., a centralized or distributed database, and associated caches and servers) that store executable instructions, routines, and data. The term specifically excludes intangible carrier waves, modulated data signals, and other such media, at least some of which are covered under the term “signal medium.” The term shall accordingly be taken to include, but not be limited to, solid-state memories, and optical and magnetic media, including memory internal or external to processors. Specific examples of non-transitory machine-readable media, non-transitory computer-readable media, and device-readable media may include non-volatile memory, including by way of example semiconductor memory devices, e.g., erasable programmable read-only memory (EPROM), electrically erasable programmable read-only memory (EEPROM), Field Programmable Gate Array (FPGA), and flash memory devices; magnetic disks such as internal hard disks and removable disks; magneto-optical disks; CD-ROM and DVD-ROM disks; solid state drives (SSD); USB flash drives; memory cards such as SD cards, microSD cards, CompactFlash cards; optical discs such as Blu-ray discs; as well as cloud storage and network attached storage (NAS). Additional examples include read-only memory (ROM), programmable read-only memory (PROM), ferroelectric RAM (FRAM), phase-change memory (PCM), resistive RAM (RRAM), memristors, racetrack memory, and magnetic tape. The terms “non-transitory machine-readable medium,” “non-transitory device-readable medium,” and “non-transitory computer-readable medium” mean the same thing and may be used interchangeably in this disclosure.

“Processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof.

A processor may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently.

A processor may be emulated in software, running on a physical processor, as a virtual processor or virtual circuit. The virtual processor may behave like an independent processor but is implemented in software rather than hardware.

“Signal Medium” may refer to any intangible medium that is capable of storing, encoding, or carrying the instructions for execution by a machine and includes digital or analog communications signals or other intangible media to facilitate communication of software or data. The term “signal medium” may include any form of a modulated data signal, carrier wave, and so forth. The term “modulated data signal” means a signal that has one or more of its characteristics set or changed in such a manner as to encode information in the signal. The terms “transmission medium” and “signal medium” mean the same thing and may be used interchangeably in this disclosure.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

The various features, steps, operations, and processes described herein may be used independently of one another or may be combined in various ways. All possible combinations and sub-combinations are intended to fall within the scope of this disclosure. In addition, certain method or process blocks, or operations may be omitted in some implementations.

The term “operation” is used to refer to elements in the drawings of this disclosure for ease of reference and it will be appreciated that each “operation” may identify one or more operations, processes, actions, or steps, and may be performed by one or multiple components.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLES

Example 1 is a computer-implemented method to analyze a contract document comprising: receiving a contract document at an AI engine; using at least one processor, extracting text from the contract document; using the AI engine to identify a contract type of the contract document from among a plurality of contract types; accessing a database comprising mappings between the plurality of contract types and respective categories of contract sections; identifying, from the database, one or more contract section categories associated with the identified contract type; dividing the extracted text into segments; for each segment: providing the segment to the AI engine; and receiving, from the AI engine, an identified contract section category corresponding to the segment; combining segments identified as corresponding to a same contract section category into a consolidated section; providing the consolidated section to a section processing engine; and generating an output comprising the identified contract section categories and corresponding text segments.
In Example 2, the subject matter of Example 1 includes, wherein the AI engine utilizes a natural language model.
In Example 3, the subject matter of Examples 1-2 includes, wherein identifying, from the database, one or more contract section categories associated with the identified contract type comprises: querying the database using the identified contract type; and receiving, from the database, the respective one or more contract section categories associated with the identified contract type.
In Example 4, the subject matter of Examples 1-3 includes, wherein dividing the extracted text into segments comprises dividing the contract document into paragraphs.
In Example 5, the subject matter of Examples 1-4 includes, wherein providing the consolidated section to a section processing engine comprises providing the consolidated section to a text summarization engine.
In Example 6, the subject matter of Example 5 includes, receiving a summary of the consolidated section from the text summarization engine.
In Example 7, the subject matter of Examples 1-6 includes, wherein providing the consolidated section to a section processing engine comprises providing the consolidated section to a question answering system.
In Example 8, the subject matter of Example 7 includes, receiving answers to questions based on the consolidated section from the question answering system.
In Example 9, the subject matter of Examples 1-8 includes, preprocessing the contract document before dividing the extracted text into segments.
In Example 10, the subject matter of Example 9 includes, wherein preprocessing comprises optical character recognition.
In Example 11, the subject matter of Examples 9-10 includes, wherein preprocessing comprises converting the contract document to plain text.
In Example 12, the subject matter of Examples 1-11 includes, wherein combining segments identified as corresponding to a same contract section category comprises concatenating text from the segments.
In Example 13, the subject matter of Examples 1-12 includes, wherein providing the consolidated section to a section processing engine comprises providing the consolidated section to a natural language generation engine.
In Example 14, the subject matter of Example 13 includes, receiving generated text continuing the consolidated section from the natural language generation engine.
In Example 15, the subject matter of Examples 1-14 includes, wherein the output further comprises the identified contract type.
In Example 16, the subject matter of Examples 1-15 includes, providing the output to a user interface for display.
Example 17 is a computer-implemented method to categorize a document comprising: receiving a document; extracting text from the document; using an artificial intelligence engine, identifying a document type corresponding to the document from among a plurality of document types; accessing a database comprising a plurality of document type categories, each document type associated with a respective set of document type categories; identifying, from the database, a set of document type categories associated with the identified document type; processing the extracted text to identify text corresponding to each of the set of document type categories associated with the identified document type; and generating an output comprising the identified text organized according to the set of document type categories.
In Example 18, the subject matter of Example 17 includes, wherein identifying, from the database, a set of document type categories associated with the identified document type comprises: querying the database using the identified document type; and receiving, from the database, the respective set of document type categories associated with the identified document type.
In Example 19, the subject matter of Examples 17-18 includes, wherein processing the extracted text comprises: dividing the extracted text into segments; for each segment: providing the segment to the artificial intelligence engine; and receiving, from the artificial intelligence engine, an identified document type category corresponding to the segment.
In Example 20, the subject matter of Examples 17-19 includes, combining identified text corresponding to a same document type category into a composite segment; and providing the composite segment to a summarization engine to generate a summary of the composite segment.
In Example 21, the subject matter of Examples 17-20 includes, wherein the artificial intelligence engine utilizes a natural language model.
In Example 22, the subject matter of Examples 17-21 includes, wherein the document comprises a legal agreement.
In Example 23, the subject matter of Example 22 includes, wherein the legal agreement comprises a contract.
In Example 24, the subject matter of Examples 17-23 includes, wherein extracting text comprises converting the document to plain text.
In Example 25, the subject matter of Example 24 includes, wherein converting the document to plain text comprises removing formatting and non-textual elements.
In Example 26, the subject matter of Examples 17-25 includes, wherein dividing the extracted text into segments further comprises removing stop words from each segment.
In Example 27, the subject matter of Examples 19-26 includes, wherein providing the segment to the artificial intelligence engine further comprises encoding the segment.
In Example 28, the subject matter of Example 27 includes, wherein encoding the segment comprises generating a vector representation of the segment.
In Example 29, the subject matter of Examples 17-28 includes, wherein generating the output further comprises formatting the identified text for readability.
In Example 30, the subject matter of Example 29 includes, wherein formatting comprises arranging the identified text into paragraphs based on the document type categories.
In Example 31, the subject matter of Examples 17-30 includes, training the artificial intelligence engine using a plurality of training documents.
In Example 32, the subject matter of Example 31 includes, wherein training the artificial intelligence engine comprises supervised learning techniques.
In Example 33, the subject matter of Examples 17-32 includes, storing the output in a searchable format.
In Example 34, the subject matter of Example 33 includes, receiving a search query and returning a portion of the output responsive to the search query.
In Example 35, the subject matter of Examples 17-34 includes, embodied as a cloud-implemented service.
In Example 36, the subject matter of Examples 17-35 includes, wherein the artificial intelligence engine comprises an ensemble of natural language processing models.
Example 37 is a computer-implemented method to process a document, the method comprising: segmenting the document into a plurality of sections; analyzing each section to determine a section type corresponding to the section; combining multiple sections having a same section type into a consolidated section; and providing the consolidated section to a section processing engine.
In Example 38, the subject matter of Example 37 includes, wherein segmenting the document into a plurality of sections comprises utilizing natural language processing to identify section boundaries.
In Example 39, the subject matter of Examples 37-38 includes, wherein segmenting the document into a plurality of sections comprises dividing the document into paragraphs.
In Example 40, the subject matter of Examples 37-39 includes, wherein analyzing each section comprises providing the section to a machine learning model and receiving a section type as output from the machine learning model.
In Example 41, the subject matter of Example 40 includes, wherein the machine learning model is a natural language processing model.
In Example 42, the subject matter of Examples 37-41 includes, wherein analyzing each section comprises comparing keywords in the section to keywords associated with known section types.
In Example 43, the subject matter of Examples 37-42 includes, accessing a database comprising mappings between section types and keywords.
In Example 44, the subject matter of Examples 37-43 includes, wherein combining multiple sections having a same section type comprises concatenating text from the sections.
In Example 45, the subject matter of Examples 37-44 includes, preprocessing the document before segmenting the document.
Example 46 is a computer-implemented method for summarizing related clauses in a document, the method comprising: receiving, by a processor, a document comprising a plurality of clauses; analyzing, by the processor, the plurality of clauses to identify related clauses in the document; consolidating, by the processor, the identified related clauses into one or more clause groups, wherein each clause group comprises related clauses from non-contiguous portions of the document; and generating, by the processor, a summary for each clause group.
In Example 47, the subject matter of Example 46 includes, wherein analyzing the plurality of clauses comprises: extracting keywords from each clause; and comparing the extracted keywords to identify clauses containing common keywords.
In Example 48, the subject matter of Examples 46-47 includes, wherein analyzing the plurality of clauses comprises utilizing a natural language processing technique to identify semantic similarities between clauses.
In Example 49, the subject matter of Examples 46-48 includes, wherein consolidating the identified related clauses into one or more clause groups comprises concatenating the text of related clauses within each group.
In Example 50, the subject matter of Examples 46-49 includes, wherein consolidating the identified related clauses into one or more clause groups comprises maintaining clause order within each group.
In Example 51, the subject matter of Examples 46-50 includes, wherein generating a summary for each clause group comprises utilizing a natural language generation technique.
In Example 52, the subject matter of Example 51 includes, wherein the natural language generation technique comprises an abstractive summarization technique.
In Example 53, the subject matter of Examples 46-52 includes, training a machine learning model utilized to analyze the plurality of clauses or generate the summary using a dataset of documents with annotated clauses.
In Example 54, the subject matter of Examples 46-53 includes, validating the generated summary against the consolidated clauses in each group.
Example 55 is a computer-implemented method for generating question-and-answer data for a document, the method comprising: receiving, by a processor, a document; analyzing, by the processor, the document to determine a document type; generating, by the processor, an expected set of questions related to the determined document type; generating, by the processor, expected answers to the set of questions based on content extracted from the document; and outputting, by the processor, the generated questions and answers as question-and-answer data for the received document.
In Example 56, the subject matter of Example 55 includes, wherein analyzing the document to determine a document type comprises using a natural language processing model to categorize the document.
In Example 57, the subject matter of Examples 55-56 includes, wherein generating an expected set of questions comprises using a natural language generation model trained on question patterns for the determined document type.
In Example 58, the subject matter of Examples 55-57 includes, wherein generating expected answers comprises: extracting key content from the document; and generating answers based on the extracted content.
In Example 59, the subject matter of Examples 55-58 includes, dividing the document into segments; and analyzing each segment to identify content to use in generating expected answers.
In Example 60, the subject matter of Examples 55-59 includes, wherein generating expected answers comprises utilizing a natural language inference model.
In Example 61, the subject matter of Examples 55-60 includes, validating the generated questions and answers using a content extraction module.
In Example 62, the subject matter of Examples 55-61 includes, wherein outputting the generated questions and answers comprises structuring the data in a pre-defined format.
In Example 63, the subject matter of Example 62 includes, wherein the pre-defined format comprises a tabular format.
In Example 64, the subject matter of Examples 55-63 includes, wherein the document type comprises one of: a legal agreement, a terms of service, a research paper, a financial report.
In Example 65, the subject matter of Examples 55-64 includes, wherein the generated questions relate to clarifying terms, obligations, and implications associated with the document type.
In Example 66, the subject matter of Examples 55-65 includes, training the natural language models used to generate the questions and answers on domain-specific data.
In Example 67, the subject matter of Examples 55-66 includes, iteratively regenerating the questions and answers until they meet pre-determined quality criteria.
In Example 68, the subject matter of Examples 55-67 includes, providing the generated question-and-answer data to a user associated with the received document.
Example 69 is a computer-implemented method for generating a user interface, the method comprising: generating a first document display section of the user interface configured to display text of an input document; generating a second analysis display section of the user interface including three tabs configured to selectively switch displayed content between: key facts associated with the input document generated using an artificial intelligence engine; clauses associated with the input document generated using the artificial intelligence engine; and question and answer information associated with the input document generated using the artificial intelligence engine.
In Example 70, the subject matter of Example 69 includes, receiving the input document.
In Example 71, the subject matter of Example 70 includes, wherein receiving the input document comprises receiving a selection of the input document via the user interface.
In Example 72, the subject matter of Examples 69-71 includes, wherein generating the first document display section comprises formatting the text of the input document for display.
In Example 73, the subject matter of Examples 69-72 includes, wherein the key facts comprise extracted figures and data from the input document.
In Example 74, the subject matter of Examples 69-73 includes, wherein the clauses comprise summarized sections of the input document.
In Example 75, the subject matter of Examples 69-74 includes, wherein the question-and-answer information comprises common questions and answers relevant to the input document.
In Example 76, the subject matter of Examples 69-75 includes, generating a summary of the input document using the artificial intelligence engine.
In Example 77, the subject matter of Example 76 includes, displaying the summary in the second analysis display section.
In Example 78, the subject matter of Examples 69-77 includes, wherein the artificial intelligence engine utilizes natural language processing techniques.
In Example 79, the subject matter of Example 78 includes, wherein the natural language processing techniques comprise neural networks.
In Example 80, the subject matter of Examples 69-79 includes, identifying a document type of the input document using the artificial intelligence engine.
In Example 81, the subject matter of Example 80 includes, accessing a database comprising mappings between document types and analysis to be performed.
In Example 82, the subject matter of Example 81 includes, wherein the artificial intelligence engine is configured based on the mapped analysis for the identified document type.
Example 83 is a computer-implemented method for parallel processing of document segments, the method comprising: accessing a document; dividing the document into a plurality of segments; in parallel, analyzing the assigned segments to determine a segment type; combining segments having a same segment type into a consolidated segment; generating a summary for each consolidated segment.
In Example 84, the subject matter of Example 83 includes, wherein dividing the document into a plurality of segments comprises utilizing natural language processing techniques to identify at least one of semantic or structural boundaries within the document.
In Example 85, the subject matter of Examples 83-84 includes, wherein the parallel analyzing of the assigned document segments comprises load balancing the segments across available processing resources.
In Example 86, the subject matter of Examples 83-85 includes, wherein the parallel analyzing of the assigned segments comprises classifying segments using a machine learning model trained on segment examples.
In Example 87, the subject matter of Examples 83-86 includes, wherein combining segments having a same segment type comprises concatenating related content from across the document.
In Example 88, the subject matter of Examples 83-87 includes, iteratively regenerating the summaries based on failed validation checks.
In Example 89, the subject matter of Examples 83-88 includes, wherein the generating of the summary comprises utilizing natural language generation techniques.
In Example 90, the subject matter of Examples 83-89 includes, extracting key information from each segment prior to combining related segments.
In Example 91, the subject matter of Examples 83-90 includes, wherein the segments comprise contractual clauses and the segment types comprise contractual topics.
Example 92 is a computer-implemented method for summarizing contractual clauses in a legal document, the method comprising: receiving a legal document comprising a plurality of contractual clauses of a defined contract type; utilizing natural language processing to identify clause boundaries within the legal document based on formatting profiles for the contract type; programmatically assigning the clauses for parallel analysis, wherein the assignment allocates processing load; analyzing the assigned clauses using a trained machine learning model to determine a contractual topic for each clause based on expected topics for the contract type; programmatically consolidating clauses having a same contractual topic into a consolidated clause group; providing the consolidated clause groups to a text summarization engine; generating a summary of each consolidated clause group; and outputting the generated summaries to a user interface.
In Example 93, the subject matter of Example 92 includes, wherein the machine learning model is trained on a set of manually annotated clauses for the contract type.
In Example 94, the subject matter of Examples 92-93 includes, wherein consolidating clauses having a same contractual topic comprises concatenating related clauses in an original order.
In Example 95, the subject matter of Examples 92-94 includes, validating the generated summaries against the source clauses according to predefined criteria.
In Example 96, the subject matter of Examples 92-95 includes, wherein outputting the generated summaries comprises formatting the summaries into sections based on contractual topics.
In Example 97, the subject matter of Examples 92-96 includes, wherein the legal document comprises a contract.
In Example 98, the subject matter of Examples 92-97 includes, wherein the contractual topics are determined based on standard topics for the contract type.
In Example 99, the subject matter of Examples 92-98 includes, iteratively regenerating invalid summaries.
In Example 100, the subject matter of Examples 92-99 includes, wherein the text summarization engine utilizes an abstractive summarization technique.
In Example 101, the subject matter of Examples 92-100 includes, wherein utilizing natural language processing comprises applying textual analysis tailored to the contract type.

### Technical Solutions

### Mapping Data Structure for Content Categorization

The document assistant system 100, according to some examples, utilizes a mapping data structure that associates different contract or document types with specific content categories or sections that are relevant to summarize for that particular type of contract or document.

For example, the document assistant system 100 may store a database or other data structure that maps the document type “Services Agreement” to content categories including “Parties”, “Term”, “Fees”, “Scope of Services”, “Service Levels”, “Confidentiality”, “Termination”, etc. A different document type such as a “Lease Agreement” would be mapped to categories like “Landlord”, “Tenant”, “Premises”, “Rent”, “Term”, “Maintenance”, “Insurance” etc.

When an input document is received, the document assistant system 100 identifies the type of document such as “Services Agreement”. It then accesses the mapping data structure to lookup the set of content categories associated with that document type. These categories provide a template for the specific information that may be extracted and summarized from this type of document.

The document assistant system 100 can then tailor the analysis and summarization of the input document based on these content categories mapped to its identified document type. Key sections can be identified and summarized according to the relevant categories. This provides an automated way to generate a summary adapted to the particular type of contract or document, rather than a generic analysis.

The mapping data structure allows the document assistant system 100 to tailor and customize the output for different document types to focus on the most pertinent content and clauses. This technique improves the usefulness and relevance of the generated summary. The mapping data structure provides a technical solution to the problem of generating customized and relevant summaries tailored to different document types. Summarizing contracts and legal documents presents challenges due to the diversity of document types and each having unique structures and important clauses. Hard coding or manually defining extraction rules for every type of document may not scale well and lack flexibility. The mapping data structure offers a more adaptable technical approach by dynamically linking document types to relevant content categories that shape the analysis.

This allows the summarization algorithms (e.g., of the section processing engine 228) to programmatically customize the output for each document type by focusing on the mapped content categories. The separation of the mapping data from the underlying technical summarization operations provides flexibility to easily expand the range of supported document types without needing to modify the core algorithms.

The mapping data structure as described above allows the system to take the raw input document, identify its type, and then tailor the analysis and summarization appropriately for that specific type of document. This provides an automated, scalable, and flexible technical solution to generate summaries adapted to diverse document types based on their unique structures and informational needs.

### Segmentation of Input Documents for Enhanced Processing

Summarizing and analyzing legal documents and contracts is challenged by long and complex documents that cannot be efficiently processed in their entirety. This poses a technical problem of how to break down large documents into logical segments that can be more readily analyzed and summarized by downstream algorithms.

The disclosed examples provide an objectively determinable technical solution by chunking or dividing the input document into segments using spacing, formatting, and textual cues within the document itself. For example, headers, section breaks, changes in formatting, and textual dividers like “Section 1”, “Article II” etc. are programmatically identified. These provide cues for segmenting the document into logical chunks or paragraphs.

Once segmented, each chunk can be independently processed and analyzed. This facilitates parallel processing as different chunks are simultaneously passed to downstream algorithms. It also allows summarization at the segment level, where related segments are consolidated into coherent summaries by topic.

The technical advantage is that chunking the document based on innate formatting and textual cues allows large documents to be automatically and intelligently segmented for enhanced processing compared to treating the document as a monolithic block of text. This facilitates scalable analysis of complex documents and contracts beyond what could be achieved without segmentation.

The described examples provide an objectively determinable technical solution rooted in the parsing and programmatic understanding of document structures and content to intelligently subdivide documents to support improved downstream analysis and summarization.

### Consolidation of Related Segments for Cohesive Summarization

Summarizing contracts and legal documents poses challenges when related content is physically separated across different parts of the document. This disjointed distribution of related concepts makes cohesive summarization difficult. This poses a technical problem of how to consolidate related textual segments distributed throughout a document to generate coherent and concise summaries.

The disclosed examples provide an objectively determinable technical solution by identifying related segments of text within a document and consolidating them programmatically for joint summarization. This allows a summary to be generated that pulls together all information on a given topic even when physically separated in the source document.

For example, clauses related to “termination” may be spread across multiple pages or sections. These segments can be identified, extracted, and merged together into a composite segment representing the full “termination” topic.

This composite segment can then be summarized to generate a cohesive summary covering all termination-related clauses. The technical advantage is the ability to programmatically identify and consolidate distributed but related content to produce summaries that connect concepts scattered throughout large documents.

The described examples of consolidating related segments provide an objectively determinable technical solution rooted in natural language processing techniques to deliver a more coherent and complete summarization of key topics, even when physically disjointed in the source document.

### Validation and Refinement of AI Output for Accuracy and Clarity

The use of AI systems to analyze and summarize legal documents raises technical challenges regarding the quality, accuracy, and clarity of the AI-generated output. Raw AI output often contains errors, repetitions, and irrelevant data that require refinement to produce clear summaries suitable for end users. This poses a technical problem of how to validate and refine rough AI output into polished summarization content.

The disclosed examples provide an objectively determinable technical solution through validation, sanitization, and post-processing of the raw AI output before providing it to users. Multiple quality checks are applied, including verifying facts/data against the source, removing redundancies, improving readability, standardizing entities, and ensuring logical flow.

The technical advantages provided by the disclosed examples include enhanced accuracy, brevity, and clarity of the final summarization delivered to users, achieved by systematically refining and enhancing the raw AI output through multiple validation steps. This provides a technical means to control the quality of the user-facing summarization content.

The example validation and post-processing of AI output provide an objectively determinable technical solution rooted in both automated analysis and human-in-the-loop techniques to transform raw AI output into high-quality summarizations suitable for end-user consumption. This addresses the core technical challenge of controlling and enhancing the clarity of AI-generated content on legal documents.

### Parallel Processing for Enhanced Throughput

Some examples of this disclosure describe an objectively determinable technical solution to the problem of low throughput when sequentially analyzing large legal documents using natural language processing techniques.

A technical problem arises because lengthy contracts and agreements cannot be efficiently processed by AI algorithms in a purely linear, sequential fashion due to the computational complexity. The technical challenge is that summarization and analysis tasks exhibit poor response times and latency that impedes productivity.

The technical solution of some examples provides a specific improvement by enabling parallel processing when executing natural language algorithms on segments of a legal document. The disclosed examples divide the input document into logical segments using formatting cues like section breaks. Each segment is then concurrently processed by distributing the segments across available computational resources. Independent AI tasks are applied simultaneously to each segment, including categorization, summarization, and information extraction algorithms.

This concurrent, parallel execution of tasks improves throughput compared to sequential analysis of the entire document. One technical advantage is that large legal documents can be intelligently segmented to allow parallel processing, enhancing performance, scalability, and reducing latency of natural language processing algorithms.

The disclosed technical examples improve the functioning of computers by leveraging parallelization techniques tailored to the domain of AI-driven legal document analysis. Segmenting legal contracts and agreements to enable concurrent AI processing provides an objectively determinable advancement over prior approaches.

What is claimed is:

1. A computer-implemented method to categorize a document comprising:
receiving a document;
extracting text from the document;
using an artificial intelligence engine, identifying a document type corresponding to the document from among a plurality of document types;
accessing a database comprising a plurality of document type categories, each document type associated with a respective set of document type categories;
identifying, from the database, a set of document type categories associated with the identified document type;
processing the extracted text to identify text corresponding to each of the set of document type categories associated with the identified document type; and
generating an output comprising the identified text organized according to the set of document type categories.

2. The computer-implemented method of claim 1, wherein identifying, from the database, a set of document type categories associated with the identified document type comprises:
querying the database using the identified document type; and
receiving, from the database, the respective set of document type categories associated with the identified document type.

3. The computer-implemented method of claim 1, wherein processing the extracted text comprises:
dividing the extracted text into segments;
for each segment:
providing the segment to the artificial intelligence engine; and
receiving, from the artificial intelligence engine, an identified document type category corresponding to the segment.

4. The computer-implemented method of claim 1, further comprising:
combining identified text corresponding to a same document type category into a composite segment; and
providing the composite segment to a summarization engine to generate a summary of the composite segment.

5. The computer-implemented method of claim 1, wherein the artificial intelligence engine utilizes a natural language model.

6. The computer-implemented method of claim 1, wherein extracting text comprises converting the document to plain text.

7. The computer-implemented method of claim 6, wherein converting the document to plain text comprises removing formatting and non-textual elements.

8. The computer-implemented method of claim 1, wherein dividing the extracted text into segments further comprises removing stop words from each segment.

9. The computer-implemented method of claim 3, wherein providing the segment to the artificial intelligence engine further comprises encoding the segment.

10. The computer-implemented method of claim 9, wherein encoding the segment comprises generating a vector representation of the segment.

11. The computer-implemented method of claim 1, wherein generating the output further comprises formatting the identified text for readability.

12. The computer-implemented method of claim 11, wherein formatting comprises arranging the identified text into paragraphs based on the document type categories.

13. The computer-implemented method of claim 1, further comprising training the artificial intelligence engine using a plurality of training documents.

14. The computer-implemented method of claim 13, wherein training the artificial intelligence engine comprises supervised learning techniques.

15. The computer-implemented method of claim 1, further comprising storing the output in a searchable format.

16. The computer-implemented method of claim 15, further comprising receiving a search query and returning a portion of the output responsive to the search query.

17. The computer-implemented method of claim 1, wherein the output is generated as part of a cloud-implemented service.

18. The method of claim 1, wherein the artificial intelligence engine comprises an ensemble of natural language processing models.

19. A computing apparatus comprising:
at least one processor; and
at least one memory storing instructions that, when executed by the at least one processor, configure the at least one processor to perform operations comprising:
receive a document;
extract text from the document;
using an artificial intelligence engine, identify a document type corresponding to the document from among a plurality of document types;
access a database comprising a plurality of document type categories, each document type associated with a respective set of document type categories;
identify, from the database, a set of document type categories associated with the identified document type;
process the extracted text to identify text corresponding to each of the set of document type categories associated with the identified document type; and
generate an output comprising the identified text organized according to the set of document type categories.

20. At least one non-transitory computer-readable storage medium including instructions that when executed by at least one processor, cause the at least one processor to perform operations comprising:
receive a document;
extract text from the document;
using an artificial intelligence engine, identify a document type corresponding to the document from among a plurality of document types;
access a database comprising a plurality of document type categories, each document type associated with a respective set of document type categories;
identify, from the database, a set of document type categories associated with the identified document type;
process the extracted text to identify text corresponding to each of the set of document type categories associated with the identified document type; and
generate an output comprising the identified text organized according to the set of document type categories.
